(19) United States
(12) Patent Application Publication
(10) Pub. No.: US 2018/0184365 A1
(43) Pub. Date: Jun. 28, 2018

(54) MULTIPLE BASIC SERVICE SETS FOR EXTENDED RANGE OPERATION

(71) Applicant: QUALCOMM Incorporated, San Diego, CA (US)

(72) Inventors: Ravi Gidvani, Fremont, CA (US); Alireza Raissinia, Monte Sereno, CA (US); Ning Zhang, Saratoga, CA (US); Ramaswamy Venkateshwaran, Dublin, CA (US)

(21) Appl. No.: 15/849,461

(22) Filed: Dec. 20, 2017

Related U.S. Application Data
(60) Provisional application No. 62/438,342, filed on Dec. 22, 2016.

(51) Int. Cl. H04W 48/16; H04W 24/02

(52) U.S. Cl. CPC H04W 48/16; H04W 24/02

(57) ABSTRACT

Methods, systems, and devices for wireless communication are described. Devices in a wireless network may be grouped into a basic service set (BSS), which may enable coordination of communications within the network. A BSS may have an associated coverage area. Some devices may be operable to communicate using extended range (ER) transmissions, which may increase the size of the coverage area associated with the BSS. In some cases, an access point (AP) may support multiple BSSs with equivalent security profiles. A first BSS may exclusively support ER transmissions, while a second BSS may support non-ER transmissions. Techniques are described for a wireless device to discover one or more of the BSSs associated with a given AP, associate with at least one of the discovered BSSs, and in some cases switch between the BSSs with equivalent security profiles. The discussed techniques may provide more efficient communications in the wireless network.

### CROSS REFERENCES

The present Application for Patent claims priority to U.S. Provisional Patent Application No. 62/438,342 by Gidvani, et al., entitled “MULTIPLE BASIC SERVICE SETS FOR EXTENDED RANGE OPERATION,” filed Dec. 22, 2016, assigned to the assignee hereof, and expressly incorporated by reference herein.

### BACKGROUND

The present disclosure relates generally to wireless communication, and more specifically to multiple basic service sets for extended range operation.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems. By way of example, a wireless multiple-access communication system may include a number of access points, each simultaneously supporting communication for multiple communication devices, otherwise known as stations (STAs). An access point (AP) may communicate with STAs on downlink channels (e.g., for transmissions from an AP to a STA) and uplink channels (e.g., for transmissions from a STA to an AP).

Some wireless communications systems may be capable of supporting multiple transmission modes (e.g., including range based transmission modes such as an extended range transmission mode in addition to standard range transmission modes). For example, different transmission modes may be associated with different data rates to achieve different ranges for signal transmission. Additionally, different transmission preamble formats may be associated with different transmission modes. STAs within the wireless communications system may communicate with an AP using different transmission modes due to, for example, STA capability, STA range relative to the AP, and so on. In some cases, an AP may need to keep track of a transmission mode associated with each STA communicating with the AP. Such scenarios may result in additional overhead (e.g., resulting from the AP transmitting duplicate beacons, groupcast transmissions, broadcast probe requests, etc., using the different transmission modes or data rates) or other inefficiencies (e.g., STAs communicating via different transmission modes may be unable to communicate with or interpret each other). Improved techniques for managing different transmission operation modes may thus be desired.

### SUMMARY

Described techniques relate to improved methods, systems, devices, or apparatuses that support multiple basic service sets for extended range (ER) operations. Some wireless networks (e.g., a wireless local access network (WLAN)) may contain multiple groups of wireless devices, which may be referred to as basic service sets (BSSs). Each BSS may be associated with a unique BSS identifier (BSSID), which may represent a media access control (MAC) address of the BSS. In some cases, the BSS includes an access point (AP) and multiple associated stations (STAs). The AP may be configured to support multiple BSSs, each BSS associated with a different BSSID. A first BSS supported by the AP may be dedicated for communications transmitted according to an ER transmission mode, while a second BSS supported by the AP may be used for one or more other transmission modes, including non-extended range (non-ER) transmission modes. In some cases the second BSS used for non-ER transmission modes may be a primary BSS used by the AP, while the first BSS used for the ER transmission mode may be a secondary BSS. In other cases, the first BSS may be the primary BSS, and the second BSS may be the secondary BSS. In some examples, the AP may be configured so that when the AP receives a transmission from another wireless device, the AP may respond to transmissions formatted according to the ER transmission mode with a transmission formatted according to the ER transmission mode (e.g., with a transmission identified by the first BSSID as from the first BSS), while the AP may respond to other transmissions, e.g., transmissions formatted according to a non-ER transmission mode, with a transmission formatted according to the non-ER transmission mode (e.g., with a transmission identified by the second BSSID as from the second BSS). A wireless device associated with a BSS identified by a BSSID and responding to or transmitting a message may be a central device (e.g., an AP or a group owner (GO)) communicating with one or more STAs (e.g., which may or may not have previously associated with the BSS).

In other examples, an AP may respond, from a first BSS, to probe requests formatted according to the ER transmission mode with a probe response formatted according to the ER transmission mode. The probe response may include an indication of a second BSS (e.g., which may support communications according to one or more non-ER transmission modes). Similarly, an AP may respond to probe requests formatted according to one of the one or more non-ER transmission modes with a probe response formatted according to the non-ER transmission mode. The probe response may include an indication of the first BSS. Thus, the STA may identify a data rate (e.g., a supported data rate) associated with (e.g., specified in) the probe response, and may associate with the AP to establish a communication link of the first BSS or the second BSS between the AP and the STA based on the probe response, which may indicate a BSS (e.g., by including a BSSID), and the identified supported data rate.

In some examples, the ER transmission mode may include a preamble format dedicated for use by such ER transmission mode. Other, non-ER transmission modes may use different preamble formats, including preamble formats that may be understandable by legacy stations. The first and second BSSs, supported by an AP for communications using different transmission modes, may have similar properties (e.g., capabilities, security profiles, etc.).

A method of wireless communication is described. The method may include receiving, at an AP, a wireless communication from a station. The AP may be configured to support a plurality of BSSs, including a first BSS to communicate using an extended range transmission mode and a second BSS to communicate using one or more non-extended range transmission modes. The method may further include identifying that the wireless communication is formatted according to the extended range transmission mode or one of the one or more non-extended range transmission modes, and performing an association and authentication procedure with the station to establish a first communication link of the first BSS between the AP and the station based at least in part on identifying that the wireless communication is formatted according to the extended range transmission mode, or a second communication link of the second BSS between the AP and the station based at least in part on identifying that the wireless communication is formatted according to the non-extended range transmission mode.

An apparatus for wireless communication is described. The apparatus may include means for receiving, at an AP, a wireless communication from a station. The AP may be configured to support a plurality of BSSs, including a first BSS to communicate using an extended range transmission mode and a second BSS to communicate using one or more non-extended range transmission modes. The apparatus may include means for identifying that the wireless communication is formatted according to the extended range transmission mode or one of the one or more non-extended range transmission modes, and means for performing an association and authentication procedure with the station to establish a first communication link of the first BSS between the AP and the station based at least in part on identifying that the wireless communication is formatted according to the extended range transmission mode, or a second communication link of the second BSS between the AP and the station based at least in part on identifying that the wireless communication is formatted according to the non-extended range transmission mode.

Another apparatus for wireless communication is described. The apparatus may include a processor, memory in electronic communication with the processor, and instructions stored in the memory. The instructions may be operable to cause the processor to receive, at the AP, a wireless communication from a station. The AP may be configured to support a plurality of BSSs, including a first BSS to communicate using an extended range transmission mode and a second BSS to communicate using one or more non-extended range transmission modes. The instructions may be operable to cause the processor to identify that the wireless communication is formatted according to the extended range transmission mode or one of the one or more non-extended range transmission modes, and perform an association and authentication procedure with the station to establish a first communication link of the first BSS between the AP and the station based at least in part on identifying that the wireless communication is formatted according to the extended range transmission mode, or a second communication link of the second BSS between the AP and the station based at least in part on identifying that the wireless communication is formatted according to the non-extended range transmission mode.

A non-transitory computer-readable medium for wireless communication is described. The non-transitory computer-readable medium may include instructions operable to cause a processor to receive, at an AP, a wireless communication from a station. The AP may be configured to support a plurality of BSSs, including a first BSS to communicate using an extended range transmission mode and a second BSS to communicate using one or more non-extended range transmission modes. The non-transitory computer-readable medium may include instructions operable to cause a processor to identify that the wireless communication is formatted according to the extended range transmission mode or one of the one or more non-extended range transmission modes, and perform an association and authentication procedure with the station to establish a first communication link of the first BSS between the AP and the station based at least in part on identifying that the wireless communication is formatted according to the extended range transmission mode, or a second communication link of the second BSS between the AP and the station based at least in part on identifying that the wireless communication is formatted according to the non-extended range transmission mode.

In some examples of the method, apparatus, and non-transitory computer-readable medium described above, the first BSS may be used by the AP for an exclusive communication of data, control, and management frames formatted according to the extended range transmission mode. In some examples of the method, apparatus, and non-transitory computer-readable medium described above, the second BSS may be used by the AP for a communication of data, control, and management frames formatted according to the one or more non-extended range transmission modes.

In some examples of the method, apparatus, and non-transitory computer-readable medium described above, the first BSS may be an extended range BSS and the second BSS may be a non-extended range BSS. In some examples of the method, apparatus, and non-transitory computer-readable medium described above, the first BSS may be associated with a first BSS identifier and the second BSS may be associated with a second BSS identifier, the first BSS identifier different from the second BSS identifier. In some examples of the method, apparatus, and non-transitory computer-readable medium described above, the first communication link of the first BSS and the second communication link of the second BSS may be associated with same operating channels. In some examples of the method, apparatus, and non-transitory computer-readable medium described above, the first communication link of the first BSS and the second communication link of the second BSS may be associated with different operating channels.

A method of wireless communication is described. The method may include transmitting a probe request formatted according to a transmission mode, the transmission mode comprising an extended range transmission mode or one or more second transmission modes, receiving, from an AP, a probe response formatted according to the transmission mode, identifying a supported data rate specified in the probe response, and determining to associate with one of a first BSS or a second BSS supported by the AP based at least in part on the received probe response and the identified supported data rate, the first BSS configured to communicate using one of the extended range transmission mode or the one or more second transmission modes, and the second BSS configured to communicate using a different one of the extended range transmission mode or the one or more second transmission modes.

An apparatus for wireless communication is described. The apparatus may include means for transmitting a probe request formatted according to a transmission mode, the transmission mode comprising an extended range transmission mode or one or more second transmission modes, means for receiving, from an AP, a probe response formatted according to the transmission mode, means for identifying a supported data rate specified in the probe response, and means for determining to associate with one of a first BSS or a second BSS supported by the AP based at least in part on the received probe response and the identified supported data rate, the first BSS configured to communicate using one of the extended range transmission mode or the one or more second transmission modes, and the second BSS configured to communicate using a different one of the extended range transmission mode or the one or more second transmission modes.

Another apparatus for wireless communication is described. The apparatus may include a processor, memory in electronic communication with the processor, and instructions stored in the memory. The instructions may be operable to cause the processor to transmit a probe request formatted according to a transmission mode, the transmission mode comprising an extended range transmission mode or one or more second transmission modes, receive, from an AP, a probe response formatted according to the transmission mode, identify a supported data rate specified in the probe response, and determine to associate with one of a first BSS or a second BSS supported by the AP based at least in part on the received probe response and the identified supported data rate, the first BSS configured to communicate using one of the extended range transmission mode or the one or more second transmission modes, and the second BSS configured to communicate using a different one of the extended range transmission mode or the one or more second transmission modes.

A non-transitory computer-readable medium for wireless communication is described. The non-transitory computer-readable medium may include instructions operable to cause a processor to transmit a probe request formatted according to a transmission mode, the transmission mode comprising an extended range transmission mode or one or more second transmission modes, receive, from an AP, a probe response formatted according to the transmission mode, identify a supported data rate specified in the probe response, and determine to associate with one of a first BSS or a second BSS supported by the AP based at least in part on the received probe response and the identified supported data rate, the first BSS configured to communicate using one of the extended range transmission mode or the one or more second transmission modes, and the second BSS configured to communicate using a different one of the extended range transmission mode or the one or more second transmission modes.

Some examples of the method, apparatus, and non-transitory computer-readable medium described above may further include processes, features, means, or instructions for receiving the probe response from the AP based at least in part on the transmission mode format associated with the probe request.

Some examples of the method, apparatus, and non-transitory computer-readable medium described above may further include processes, features, means, or instructions for receiving, in the probe response from the first BSS of the AP, an indication of the second BSS based at least in part on a transmission mode supported by the second BSS, the indication received in the probe response. Some examples of the method, apparatus, and non-transitory computer-readable medium described above may further include processes, features, means, or instructions for determining to associate with the second BSS based at least in part on the received indication.

Some examples of the method, apparatus, and non-transitory computer-readable medium described above may further include processes, features, means, or instructions for associating with the determined one of the first BSS or the second BSS. Some examples of the method, apparatus, and non-transitory computer-readable medium described above may further include processes, features, means, or instructions for receiving, from the AP, a request to move to being associated with a different one of the first BSS or the second BSS based at least in part on a transmission mode supported by the second BSS.

Some examples of the method, apparatus, and non-transitory computer-readable medium described above may further include processes, features, means, or instructions for identifying a change in location of the station. Some examples of the method, apparatus, and non-transitory computer-readable medium described above may further include processes, features, means, or instructions for transmitting a query to the access point for a list of candidate target BSSs based at least in part on the change in location and a transmission mode supported by the second BSS. Some examples of the method, apparatus, and non-transitory computer-readable medium described above may further include processes, features, means, or instructions for receiving a query response comprising one or more candidate target BSSs of the AP.

Some examples of the method, apparatus, and non-transitory computer-readable medium described above may further include processes, features, means, or instructions for receiving a beacon from the AP. Some examples of the method, apparatus, and non-transitory computer-readable medium described above may further include processes, features, means, or instructions for identifying signal strength associated with the received beacon. Some examples of the method, apparatus, and non-transitory computer-readable medium described above may further include processes, features, means, or instructions for determining to associate with the one of the first BSS or the second BSS based at least in part on the received probe response, the identified signal strength, and a supported transmission mode for communication in the second BSS.

Some examples of the method, apparatus, and non-transitory computer-readable medium described above may further include processes, features, means, or instructions for identifying a location of the station with reference to the AP, a proximity of the station with reference to the AP, or some combination thereof. Some examples of the method, apparatus, and non-transitory computer-readable medium described above may further include processes, features, means, or instructions for determining to associate with the first BSS or the second BSS based at least in part on the received probe response, the identified location, proximity, or some combination thereof, and a transmission mode supported by the second BSS. In some examples of the method, apparatus, and non-transitory computer-readable medium described above, the first BSS and the second BSS may have an equivalent security profile.

In some examples of the method, apparatus, and non-transitory computer-readable medium described above, the apparatus may be a wireless communication terminal and further comprises an antenna and a transceiver. In some examples of the method, apparatus, and non-transitory computer-readable medium described above, the probe response includes a BSS identifier associated with the first BSS or the second BSS.

A method of wireless communication is described. The method may include receiving, from a station and by the AP, a probe request identifying a first BSS and formatted according to a transmission mode, the transmission mode comprising an extended range transmission mode or one or more second transmission modes, and the AP configured to support a plurality of BSSs, including the first BSS and a second BSS, one of the first BSS or the second BSS to communicate using the extended range transmission mode, and a different one of the first BSS or the second BSS to communicate using one or more second transmission modes, transmitting, to the station, an identifier of the second BSS in a probe response formatted according to the transmission mode, and receiving, from the station, a request of an association and authentication procedure based at least in part on the identifier of the second BSS.

An apparatus for wireless communication is described. The apparatus may include means for receiving, from a station and by the AP, a probe request identifying a first BSS and formatted according to a transmission mode, the transmission mode comprising an extended range transmission mode or one or more second transmission modes, and the AP configured to support a plurality of BSSs, including the first BSS and a second BSS, one of the first BSS or the second BSS to communicate using the extended range transmission mode, and a different one of the first BSS or the second BSS to communicate using one or more second transmission modes, means for transmitting, to the station, an identifier of the second BSS in a probe response formatted according to the transmission mode, and means for receiving, from the station, a request of an association and authentication procedure based at least in part on the identifier of the second BSS.

Another apparatus for wireless communication is described. The apparatus may include a processor, memory in electronic communication with the processor, and instructions stored in the memory. The instructions may be operable to cause the processor to receive, from a station and by the AP, a probe request identifying a first BSS and formatted according to a transmission mode, the transmission mode comprising an extended range transmission mode or one or more second transmission modes, and the AP configured to support a plurality of BSSs, including the first BSS and a second BSS, one of the first BSS or the second BSS to communicate using the extended range transmission mode, and a different one of the first BSS or the second BSS to communicate using one or more second transmission modes, transmit, to the station, an identifier of the second BSS in a probe response formatted according to the transmission mode, and receive, from the station, a request of an association and authentication procedure based at least in part on the identifier of the second BSS.

A non-transitory computer-readable medium for wireless communication is described. The non-transitory computer-readable medium may include instructions operable to cause a processor to receive, from a station and by the AP, a probe request identifying a first BSS and formatted according to a transmission mode, the transmission mode comprising an extended range transmission mode or one or more second transmission modes, and the AP configured to support a plurality of BSSs, including the first BSS and a second BSS, one of the first BSS or the second BSS to communicate using the extended range transmission mode, and a different one of the first BSS or the second BSS to communicate using one or more second transmission modes, transmit, to the station, an identifier of the second BSS in a probe response formatted according to the transmission mode, and receive, from the station, a request of an association and authentication procedure based at least in part on the identifier of the second BSS.

Some examples of the method, apparatus, and non-transitory computer-readable medium described above may further include processes, features, means, or instructions for identifying that the probe request may be formatted according to the first transmission mode. Some examples of the method, apparatus, and non-transitory computer-readable medium described above may further include processes, features, means, or instructions for refraining from transmitting a probe response based at least in part on the identification.

Some examples of the method, apparatus, and non-transitory computer-readable medium described above may further include processes, features, means, or instructions for associating the station with the second BSS. Some examples of the method, apparatus, and non-transitory computer-readable medium described above may further include processes, features, means, or instructions for transmitting, to the station, a request for the station to move from being associated with the second BSS to being associated with the first BSS.

Some examples of the method, apparatus, and non-transitory computer-readable medium described above may further include processes, features, means, or instructions for identifying a change in location of the station. Some examples of the method, apparatus, and non-transitory computer-readable medium described above may further include processes, features, means, or instructions for transmitting a list of candidate target BSSs to the station based at least in part on the identification. In some examples of the method, apparatus, and non-transitory computer-readable medium described above, the first BSS and the second BSS may have an equivalent security profile.

### BRIEF DESCRIPTION OF THE DRAWINGS

FIG. 1 illustrates an example of a system for wireless communication that supports multiple basic service sets for extended range (ER) operation in accordance with aspects of the present disclosure.

FIG. 2 illustrates an example of a block diagram that supports multiple basic service sets for ER operation in accordance with aspects of the present disclosure.

FIG. 3 through 8 illustrates examples of a process flows that supports multiple basic service sets for ER operation in accordance with aspects of the present disclosure.

FIGS. 9 and 10 show examples of process flows that support switching between multiple basic service sets for ER operation in accordance with various aspects of the present disclosure;

FIGS. 11-13 show block diagrams of devices configured for use in wireless communication, in accordance with various aspects of the present disclosure;

FIG. 14 shows a block diagram of an access point for use in wireless communication, in accordance with various aspects of the present disclosure;

FIGS. 15-17 show block diagrams of devices configured for use in wireless communication, in accordance with various aspects of the present disclosure;

FIG. 18 shows a block diagram of a station for use in wireless communication, in accordance with various aspects of the present disclosure; and

FIGS. 19-24 are flow charts illustrating examples of methods for wireless communication, in accordance with various aspects of the present disclosure.

### DETAILED DESCRIPTION

In some wireless network infrastructures, a station (STA) (e.g., a client device) may scan, associate, and connect to a basic service set (BSS) associated with one or more access points (APs). In some cases, a BSS may contain a mix of STAs with differing levels of physical layer capabilities. Some STAs may support a physical layer convergence procedure (PLCP) protocol data unit (PPDU) format, which may be defined as an extended range (ER) PPDU. An ER PPDU may support longer range communications (e.g., by increasing the power of certain portions of a preamble or including redundant bits in a preamble that may enable more robust performance). In some cases, such a preamble may be referred to as a power-boosted preamble. In some cases, the longer range communication may come at the expense of decreased data rates (e.g., because of a longer preamble) compared to shorter range communications. The decreased data rates associated with the ER communications may be referred to as ER data rates. In some cases, having a power boosted preamble may introduce challenges in a BSS that has a mixture of STAs or APs, some of which may be able to receive ER transmissions and others which may not be able to receive (e.g., process) ER PPDUs. As an example, the preamble of a PPDU may have a power boost (e.g., 3 dB), which may be interpreted only by certain STAs (e.g., by 802.11ax STAs). In some cases, these STAs may be far enough to receive the ER PPDUs but may be unable to receive non-boosted transmissions (e.g., transmissions sent using a non-extended range (non-ER) preamble).

As another example, a control frame (e.g., for acknowledgement (ACK), block ACK, etc.) may be sent from a STA (e.g., in response to reception of an ER single user (SU) PPDU). In some cases (e.g., in order to reach a distant AP 105), the transmitting STA may send the control frame using ER data rates (e.g., instead of non-ER data rates, which may be used in some cases to ensure that all STAs in the BSS receive the control frame and update their network allocation vector (NAV) accordingly). Since some STAs present in the BSS may not be able to interpret control frames sent in an ER format (e.g., an ER frame), those STAs may not update their NAV. In some cases, such a situation may result in e.g., decreased throughput for the WLAN 100 as a result of losing the advantage of NAV protection offered by the 802.11 protocol (e.g., because of an increase in collisions in the wireless local area network (WLAN)). As a third example, beacons and other management frames which maintain the connectivity of the BSS may typically be sent using non-ER data rates, e.g., to ensure that all STAs in the BSS can interpret them. Since a purpose of the ER PPDU is to increase the range of a BSS, in some cases all beacons and management frames for a given BSS may be sent in ER PPDU format. Some STAs in the BSS may not be able to interpret these transmissions. Thus, in some cases dual beaconing may be required for all STAs associated with a given BSS to receive the beacon information.

In some cases, a method of dual beaconing may involve an AP sending the same beacon and/or broadcast/multicast (BC/MC) data frame twice, e.g., once using non-ER data rates and once using ER data rates. Such a solution may involve a wireless device (e.g., a STA or an AP) keeping track of the type of data rate (e.g., ER or non-ER) for management frames (e.g., beacons, probe responses, etc.) and ignoring the duplicated data. This solution (e.g., sending duplicated beacons, keeping track of ER or non-ER frames, etc.) may represent a large amount of overhead for a WLAN (e.g., a waste of power, a waste of the medium, etc.). More efficient solutions may be desired.

A wireless communications system may use different BSSs, e.g., to coordinate transmissions between different groups of devices. For example, a first BSS may be associated with (e.g., dedicated to) an ER transmission mode for communication with the AP, while a second BSS may be associated with (e.g., dedicated to) a non-ER transmission mode with the AP. In some cases, a STA may communicate using a transmission operation mode according to a format supported by a discovered BSS. For example, a STA may identify an ER beacon or transmit an ER probe during scanning, and subsequently associate with the ER BSS of the AP. In some cases, a STA may obtain an ER BSSID via an access network query protocol (ANQP) query. The ANQP may involve the STA and an AP, which may indicate the ER BSSID in a transmission using a non-ER BSS (e.g., a BSS that supports non-ER formats). Alternatively, the STA may obtain a non-ER BSSID from the AP via a transmission using the ER BSS (e.g., a BSS that supports ER formats). Further a STA may switch between an ER BSS and a non-ER BSS with a similar, equivalent, or identical security profile (e.g., sharing an authentication type, encryption type, etc.). For example, when a STA observes changes in data rates due to STA motion, the STA may use multiband operation (MBO) to move from one BSS to another. That is, if a STA observes decreasing data rates and/or decreasing signal strength (e.g., received signal strength indicator (RSSI)) due to the STA moving away from the serving AP, the STA may use MBO to move from being associated with a non-ER BSS of an AP to being associated with an ER BSS of the AP. Additionally or alternatively, an AP may observe loading conditions of different BSSs, which may influence decisions to move a STA from one BSS to another.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

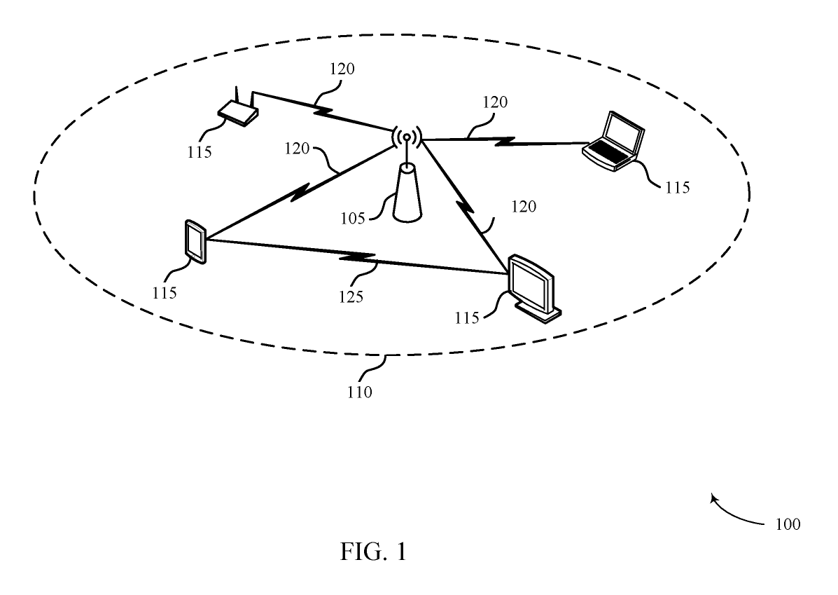

FIG. 1 illustrates a WLAN 100 (also known as a Wi-Fi network) configured in accordance with various aspects of the present disclosure. The WLAN 100 may include an AP 105 and multiple associated STAs 115, which may represent devices such as wireless communication terminals, including mobile stations, phones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a BSS. The various STAs 115 in the network are able to communicate with one another through the AP 105. Also shown is a coverage area 110 of the AP 105, which may represent a basic service area (BSA) of the WLAN 100. For brevity, aspects of the present disclosure are described using an AP as the central device in the BSS. However, the central device could represent some other coordinating device (e.g., a group owner (GO) in an ad hoc network) without deviating from the scope of the disclosure.

In some cases, a STA 115 may be located in the intersection of more than one coverage area 110 and may associate with more than one AP 105. A single AP 105 and an associated set of STAs 115 may be referred to as a BSS. An ESS may refer to a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. A STA 115 may communicate with a given AP 105 via a wireless link 120. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105 via wireless links 120, but may not receive (e.g., detect) the transmissions of the other. Such a situation may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request-to-send (RTS) packet transmitted by a sending STA 115 (or AP 105) and a clear-to-send (CTS) packet transmitted by the receiving STA 115 (or AP 105). This may alert other devices within range of the sender and receiver not to transmit for the duration of the primary transmission. Thus, RTS/CTS may help mitigate a hidden node problem.

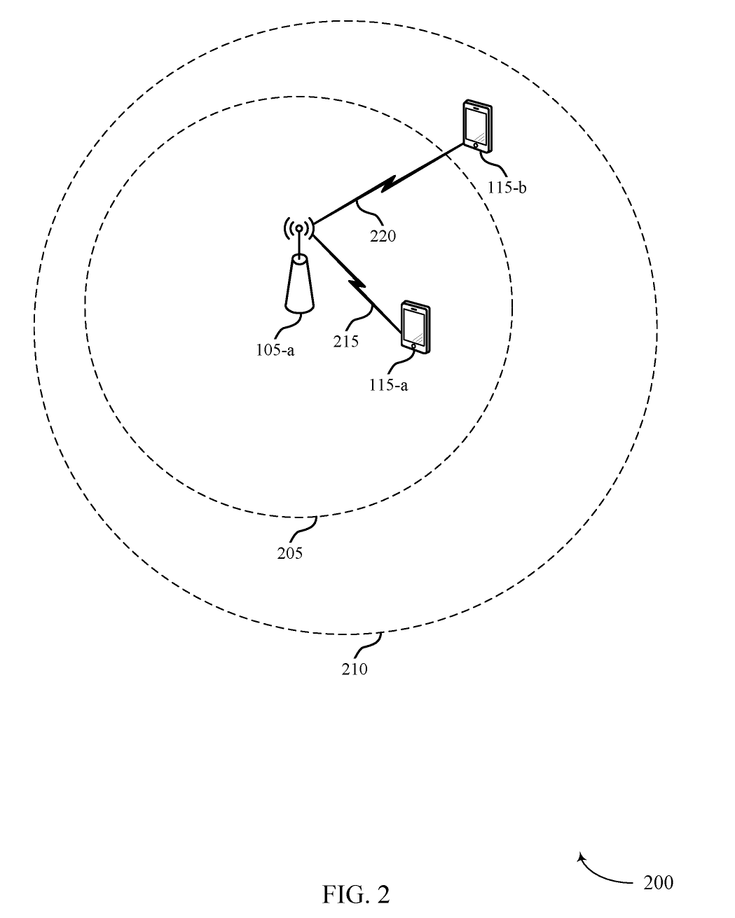

FIG. 2 illustrates an example of a WLAN 200 that supports multiple BSSs for ER and/or non-ER operation in accordance with various aspects of the present disclosure. WLAN 200 may include an AP 105-a and STAs 115-a and 115-b, each of which may be an example of the corresponding device described with respect to FIG. 1.

Some devices (e.g., APs 105 and/or STAs 115) may support a multiple basic service set identifier (MBSSID) element (e.g., in accordance with IEEE 802.11ax guidelines). In some cases, support of MBSSID elements may allow an AP 105-a to have the capability to support multiple BSSs (e.g., which may have identical or equivalent security profiles) such that the AP 105-a may not be required to send some transmissions (e.g., beacons, broadcast frames, etc.) multiple times. In some cases, at least one of the multiple BSSs may be dedicated (e.g., exclusively) to support ER capabilities (e.g., may be an ER B SS).

As an example, AP 105-a may be associated with at least two BSSs (e.g., a primary BSS and a secondary BSS) with similar (e.g., identical or equivalent) security profiles, features, functionality, and capabilities. Each BSS may be associated with a corresponding coverage area. Referring to FIG. 2, the primary BSS (e.g., a non-ER BSS) may be associated with coverage area 205 and a secondary BSS (e.g., an ER BSS) may be associated with coverage area 210. In some examples described herein, the ER BSS may be or be referred to as the primary BSS, and the non-ER BSS may be or be referred to as the secondary BSS. Accordingly, the terms primary BSS or secondary BSS are not intended to be used synonymously with either ER BSS or non-ER BSS. In aspects of the present disclosure, coverage area 205 may be completely within coverage area 210 as shown. Alternatively, coverage areas 205 and 210 may partially overlap. In each case, coverage area 205 may represent a smaller geographic area than coverage area 210. Although shown as being circular, the coverage areas may be any suitable shape (e.g., they may be sectors in the case of beamformed transmissions, may have irregular shapes, etc.).

In aspects, the secondary BSS may include one or more STAs 115 that are located far off from the AP 105-a and may support ER transmissions (e.g., ER capabilities such power-boosted preambles, ER data rates, etc.). In some cases, the secondary BSS may exclusively support ER transmissions. STA 115-b may represent an example of a distant STA 115 (e.g., relative to AP 105-a) that is associated with coverage area 210. Alternatively, STA 115-a may be an example of a STA 115 that is nearby to AP 105-a and may be associated with coverage area 205. As described above, STAs 115-a and 115-b may communicate with AP 105-a over wireless links 215 and 220, respectively. In aspects of the present disclosure, wireless link 220 may carry ER transmissions (e.g., transmissions with power-boosted preambles) while wireless link 215 may carry non-ER transmissions. STAs 115-a and 115-b may also be in communication with other APs 105, other STAs 115, and/or each other without deviating from the scope of the present disclosure. Thus, in some examples, a STA 115 that is associated with a primary (e.g., non-ER) BSS (e.g., STA 115-a) may be an example of a device that does not support communication using ER data rates. Alternatively, STA 115-a may support communication using ER data rates, but may operate in a non-ER mode when it is in coverage area 205. A STA 115 that is associated with an ER BSS (e.g., STA 115-b) may be required to support communication using ER data rates.

In some cases, the ER BSS may transmit management frames (e.g., beacons, probes, etc.) using ER rates. In some cases, the ER BSS may only support transmission (e.g., of all data, control, and management frames including beacons) in ER format. In the present example, STA 115-b (e.g., a STA 115 associated with the secondary BSS) may not respond to non-ER frames. In some cases, the STA 115-b may not receive (e.g., be out of range of) the non-ER frames. Alternatively, STAs 115 associated with the primary BSS (e.g., STA 115-a) may not respond to ER frames. Thus, the ER BSS may support reception and transmission using ER data rates while the non-ER BSS (e.g., the primary BSS) may support reception and transmission using non-ER data rates. The ER BSS and/or the non-ER BSS may support MBO. Additionally or alternatively one or both of the BSSs may support Passpoint and have ANQP elements. An ER BSS may operate on the same or different channel as a non-ER BSS. In some cases, e.g., if an AP 105-a can support simultaneous beaconing on multiple channels, it may be preferable to operate the ER BSS and the non-ER BSS on different channels (e.g., to avoid interference).

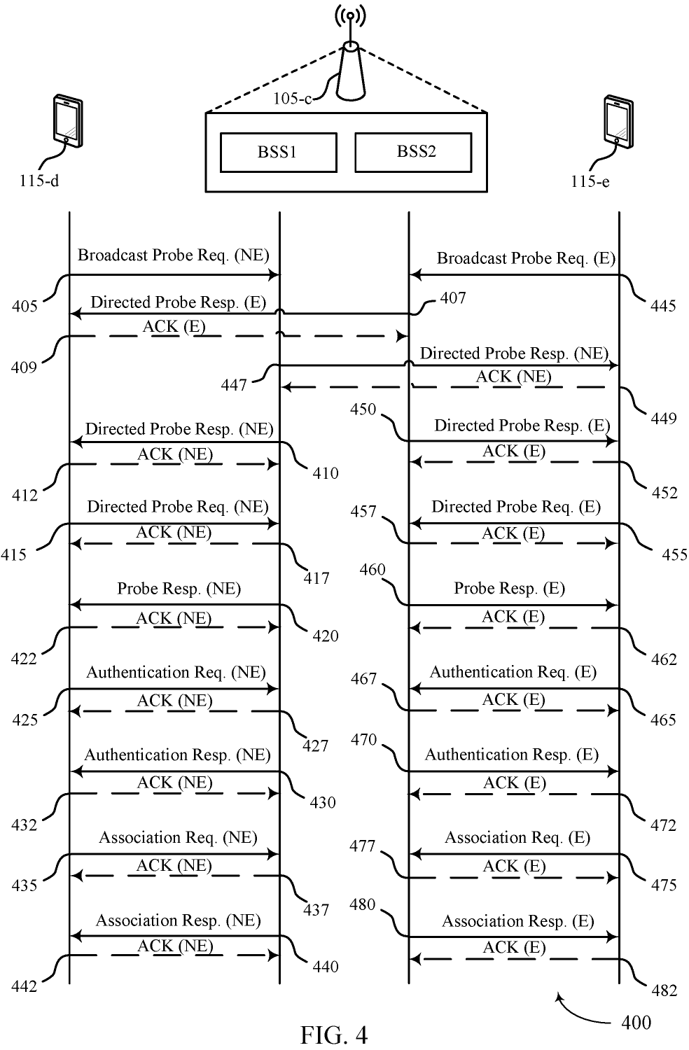

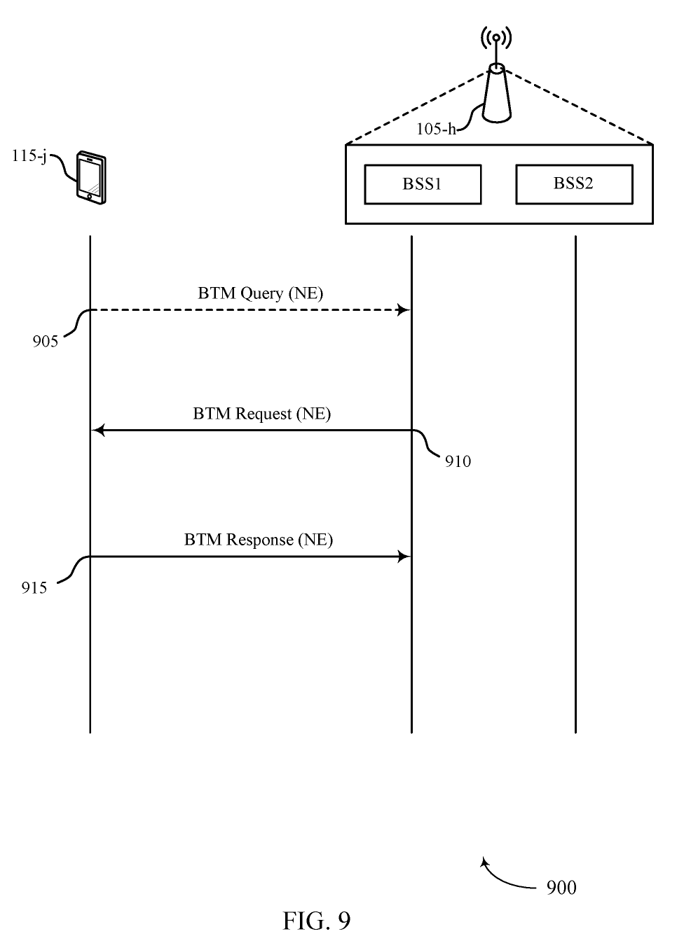

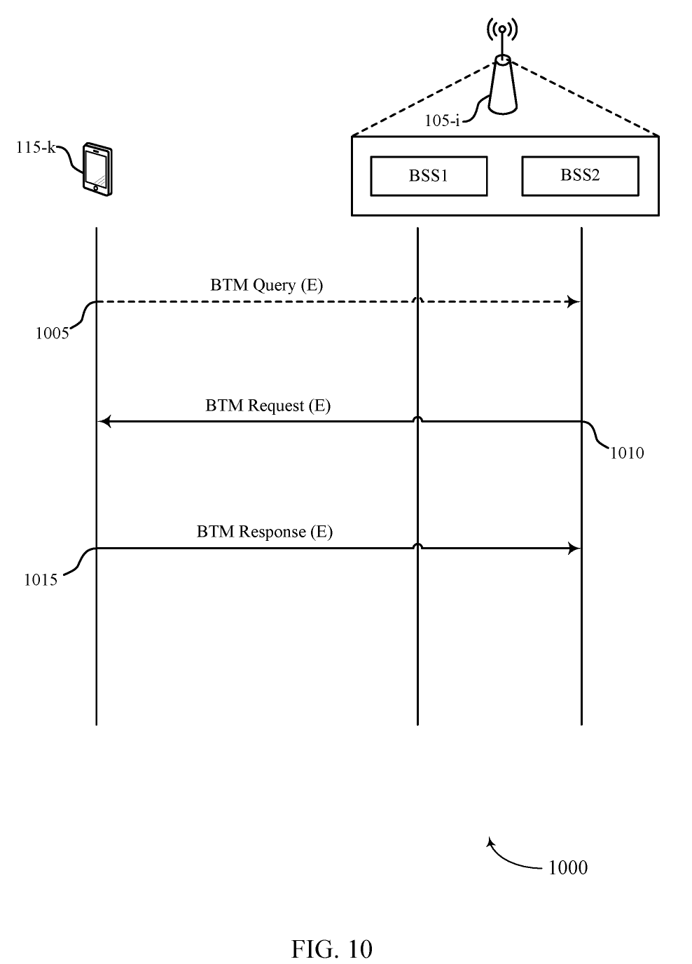

There may be multiple ways for a STA 115 to discover the number and type of BSSs supported by an AP 105 (or multiple APs 105 that may be part of the same ESS). Some example discovery techniques are discussed below with reference to FIGS. 4 through 8. As discussed below with reference to FIGS. 9 and 10, in some cases (e.g., when a STA 115 that is connected to the primary BSS is moving away from AP 105-a), it may be desirable to transition the device from the primary BSS to the secondary BSS. The reverse situation (e.g., when a STA 115 that is connected to a secondary BSS and is moving towards AP 105-a is transitioned from the secondary BSS to the primary BSS) is also possible.

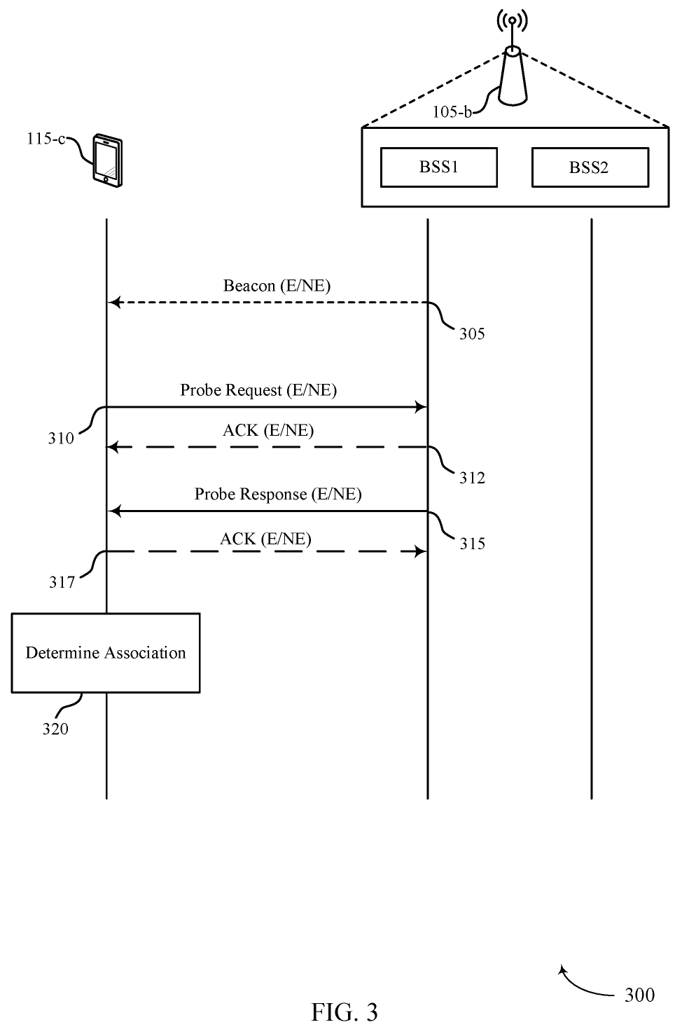

FIG. 3 illustrates an example of a process flow 300 that supports multiple BSSs for ER and/or non-ER operation in accordance with various aspects of the present disclosure. FIG. 3 illustrates a STA 115-c and an AP 105-b, each of which may be an example of the corresponding devices described with reference to FIGS. 1 and 2. In this example, AP 105-b and STA 115-c may be examples of wireless devices that support MBSSID elements. Accordingly, AP 105-b is illustrated as supporting BSS1 and BSS2, although more than two BSSs may be supported without deviating from the scope of the present disclosure. In the present example, BSS1 or BSS2 may represent an ER BSS, while the other BSS2 or BSS1, respectively, may represent a non-ER BSS, which may have the same or similar security profile and other characteristics.

At step 305, STA 115-c may optionally receive a beacon from AP 105-b. As an example, STA 115-c may passively scan for beacon transmissions (e.g., and may switch channels to find these transmissions). Accordingly, AP 105-b may transmit beacons periodically, and the beacon frame may carry, e.g., regulatory information, capability information, information for managing the BSS, etc. In some cases, the beacon may be formatted according to the data rates supported by the given BSS (e.g., ER data rates or non-ER data rates). In the present example, the beacon may be transmitted using non-ER data rates (e.g., in the case that BSS1 represents a non-ER BSS). In aspects of the present disclosure (e.g., with reference to FIGS. 3 through 8), transmissions may be designated as E (formatted according to an ER transmission mode) or NE (formatted according to a non-ER transmission mode). Alternatively, BSS1 may be associated with ER data rates, and the beacon may be transmitted accordingly (e.g., using ER-data rates). Accordingly, beacon of step 305 is designated as E/NE in that it may be an ER beacon or a non-ER beacon depending on the scenario, with each case falling within the scope of the present disclosure. In some cases, STA 115-c may identify a signal strength associated with the received beacon.

At step 310, STA 115-c may transmit one or more probe requests. In some cases, the probe request may be broadcast. Additionally or alternatively, the probe request may be directed to a given AP 105. As an example, in the case that STA 115-c receives and decodes information associated with a beacon signal at step 305, the probe request may be formatted and directed accordingly. As an example, STA 115-c may transmit a probe request frame on a channel where it is seeking a BSS. The probe request may include a request for information including a service set identifier (SSID), a BSSID, and a destination address. In some cases, the probe request may be formatted according to a transmission mode based in part on a received beacon signal (e.g., may have the same format as the beacon signal or may have a different format). Other factors may also influence the format of the probe request (e.g., location information, network conditions, etc.).

At step 312, AP 105-b may transmit an ACK message (e.g., to confirm receipt of the probe request. The ACK may be transmitted using the same format (e.g., E or NE) as the probe request.

At step 315, AP 105-b may receive the probe request and send a probe response to the STA 115. In some cases, the probe response may only be transmitted if the AP 105-b recognizes the SSID and BSSID in the probe request. In some cases, multiple APs 105 may respond to a broadcast probe request (e.g., using normal channel access procedures to avoid collisions). The probe response may be sent from BSS1 or BSS2 based at least in part on the transmission mode format associated with the probe request (e.g., the format of the probe response may be based in part on the format of the probe request). At step 317, STA 115-c may transmit an ACK to AP 105-b.

At step 320, STA 115-c may determine to associate with a BSS of AP 105-b based on the probe request. Thus, after receiving the probe request at step 315, STA 115-c may participate in an association and authentication procedure with BSS1 or with BSS2. As an example, STA 115-c may receive an indication from BSS1 (e.g., in the probe response) of the presence of BSS2 and determine to associate with BSS2 based at least in part on the received indication. Additionally or alternatively, the association may be based at least in part on the signal strength of the beacon of step 305. In some cases, the association may be based at least in part on a location of the STA 115-c (e.g., in the case that location information is available).

In some cases a STA 115-c may initially associate with either BSS1 or BSS2 and receive, from AP 105-b, a request to move to being associated with the BSS with which it is currently not associated, as discussed with reference to FIGS. 9 and 10.

Although some features above are discussed from the perspective of STA 115-c, corresponding operations at the AP 105-b also fall within the scope of the present disclosure. Thus, at step 305, AP 105-b may optionally transmit a beacon associated with BSS1. As described herein, BSS1 may represent a BSS created by AP 105-b exclusively for ER or non-ER communications (e.g., but not both). BSS2 may represent a BSS created by AP 105-b to support communications using the format not supported by BSS1. At step 310, AP 105-b may receive a probe request from STA 115-c over BSS1 (e.g., the format of the probe request may be supported by BSS1). As described above, the probe request may be formatted according to a transmission mode (e.g., an ER transmission mode or one or more second, non-ER transmission modes). At step 315, AP 105-b may transmit a probe response using the format supported by BSS1 to STA 115-c (e.g., in response to the received probe request). As described above, the probe response may be formatted according to the transmission mode of the probe request and may contain an indication of one or more properties of BSS2 (e.g., a BSSID). In some cases, following step 320, AP 105-b may receive a request of an authentication and association procedure from STA 115-c. In some cases, the request of the authentication and association procedure may be transmitted using a format supported by BSS2 (e.g., the opposite BSS that received the probe request at step 310).

In some cases, the AP 105-b may identify a format of the probe request at step 310 and refrain from transmitting a response to the STA 115-c using a format supported by BSS2 based on the identification. In some cases, as discussed with reference to FIGS. 9 and 10, the AP 105-b may identify a change in location of the STA 115-c and transmit a list of candidate target BSSs of AP 105-b (e.g., a list of BSSIDs) to the station based at least in part on the identification.

With respect to FIGS. 3 through 8, some steps are explicitly shown as being followed by ACK transmissions. In some cases, ACKs may not be explicitly shown. However, it is to be understood that any directed (e.g., unicast) transmission of the present disclosure may or may not be followed by an ACK. In some cases, the ACK may be incorporated into a subsequent message (e.g., ACK of step 312 may be incorporated into probe response of step 315). An ACK may be formatted according to its corresponding message (e.g., in the case that probe request of step 310 is a NE transmission, ACK of step 312 may also be an NE transmission).

FIG. 4 illustrates an example of a process flow 400 that supports multiple BSSs for ER and/or non-ER operation in accordance with various aspects of the present disclosure. FIG. 4 illustrates a STA 115-d, STA 115-e, and an AP 105-c, each of which may be an example of the corresponding devices described above. In this example, AP 105-c is illustrated as supporting BSS1 and BSS2, although more than two BSSs may be supported without deviating from the scope of the present disclosure. In the present example, BSS1 may represent a non-ER BSS while BSS2 may represent an ER BSS. Accordingly, referring to FIG. 2, BSS1 may be associated with coverage area 205 while BSS2 may be associated with coverage area 210. In this example, BSS1 may only support transmissions using non-ER data rates while BSS2 may only support transmissions using ER data rates.

At step 405, STA 115-d may broadcast a probe request, which may be an example of the probe request described above. In this example, the probe request may be formatted according to non-ER data rates (e.g., may be designated as NE). The format of the probe request may be based on a number of factors including distance of STA 115-d from an AP 105, stored information, one or more received beacon signals, etc.

At steps 407 and 410, AP 105-c may transmit a directed probe response to STA 115-d using a format supported by BSS2 and BSS1, respectively. The directed probe response from BSS1 may be transmitted using the same format as the probe request from step 405 (e.g., NE format), while the directed probe response from BSS2 may be transmitted using a different format (e.g., E format). At steps 409 and 412, STA 115-d may transmit an appropriately formatted ACK (e.g., E format and NE format, respectively) to confirm receipt of the corresponding probe response.

Subsequently, at step 415, STA 115-d may (e.g., optionally) transmit a directed probe request to AP 105-c, which may be followed by an appropriately formatted ACK from AP 105-c at step 417. Accordingly, at step 420, AP 105-c may transmit a second probe response at step 420, which may be followed by an appropriately formatted ACK from STA 115-d at step 422. In some cases, the transmissions of steps 415 and 420 may be optional (e.g., they may only apply when STA 115-d requires additional information from AP 105-c that was not included in the probe response of step 410). Additionally, the transmissions of steps 415 and 420, and their corresponding ACK of step 417 and ACK of step 422 may be formatted using to non-ER data rates.

At step 425, STA 115-d may initiate an authentication and association procedure. Authentication may refer to a process by which STA 115-d and AP 105-c establish their identity to a mutually acceptable level. Examples of authentication methods include open system authentication and shared key authentication. In the present example, the authentication procedure includes transmission of an authentication request at step 425 and an authentication response at step 430. Additional transmissions (e.g., a second authentication request and a second authentication response) may be part of the authentication procedure. In the present example, the authentication request and response are transmitted using non-ER data rates.

At step 425, STA 115-d may transmit an authentication request (e.g., which may be followed by an appropriately formatted ACK of step 427 from AP 105-c). At step 430, AP 105-c may transmit an authentication response (e.g., using the same format as authentication request of step 425), which may also be followed by an appropriately formatted ACK of step 432 from STA 115-d.

At step 435, STA 115-d may transmit an association request to AP 105-c (e.g., which may be followed by an appropriately formatted ACK of step 437 from AP 105-c). At step 440, AP 105-c may transmit an association response (e.g., which may be followed by an appropriately formatted ACK of step 442 from STA 115-d). The association transmissions may be formatted using non-ER data rates. Association may provide a mapping between the STA 115-d and the AP 105-c that allows messages within a wireless communications system (e.g., a WLAN 100) to reach AP 105-c and ultimately to reach STA 115-d.

Process flow 400 also displays a second STA 115-e, which may communicate with BSS2 of AP 105-c. In the present example, BSS2 may represent an example of an ER BSS as discussed above.

Accordingly, the transmissions of steps 445 through 482 may be analogous to the corresponding transmissions of steps 405 through 442, except that the transmissions of steps 445 through 482 may primarily be examples of ER transmissions (e.g., may contain power-boosted preambles, etc.). In some cases, the transmissions of steps 445 through 482 may include a non-ER directed probe response at step 447 (e.g., in response to an ER broadcast probe request at step 445) and a corresponding non-ER ACK at step 449. Accordingly, an AP 105 receiving a broadcast probe request from a given STA 115 may respond with two directed probe responses (e.g., one in an ER format supported by a first BSS and another in a non-ER format supported by a second BSS). Each directed probe response may contain information about either or both BSSs or other information related to the wireless communications system.

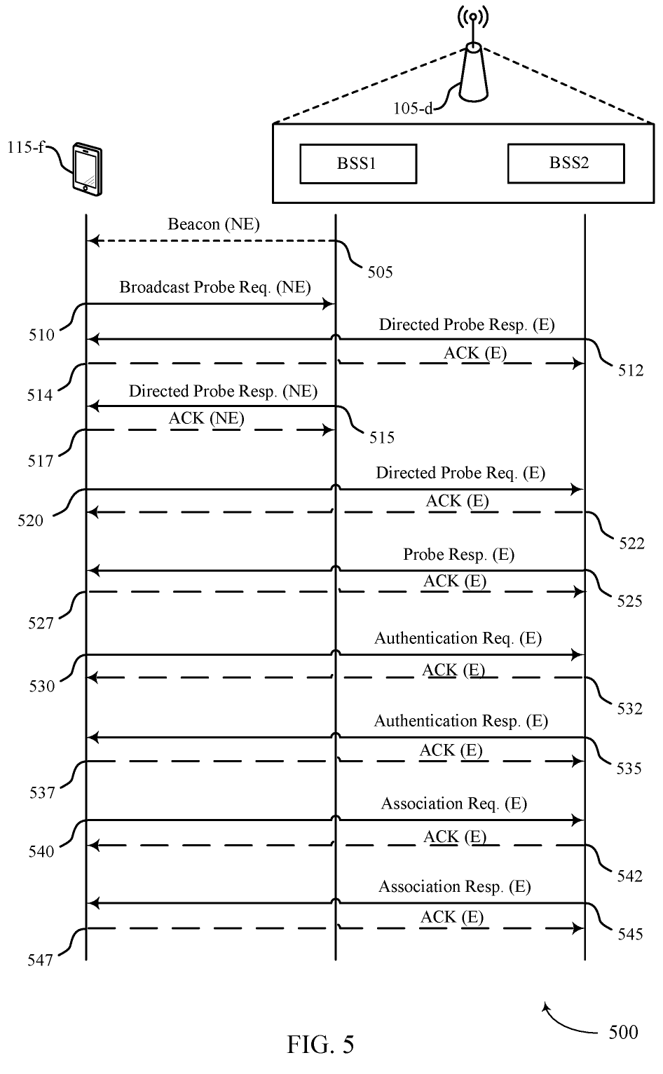

FIG. 5 illustrates an example of a process flow 500 that supports multiple BSSs for ER and/or non-ER operation in accordance with various aspects of the present disclosure. Specifically, FIG. 5 illustrates an example of a process by which a STA 115-f may discover and associate with an ER BSS of an AP 105-d. FIG. 5 illustrates a STA 115-f and an AP 105-d, each of which may be an example of the corresponding devices described above. In this example, AP 105-d is illustrated as supporting communications in a first BSS1 and supporting communications in a second BSS2, although more than two BSSs may be supported without deviating from the scope of the present disclosure. In the present example, BSS1 may represent a non-ER BSS while BSS2 may represent an ER BSS. Accordingly, referring to FIG. 2, BSS1 may be associated with coverage area 205 while BSS2 may be associated with coverage area 210. In this example, BSS1 may support transmissions using non-ER data rates while BSS2 may only support transmissions using ER data rates.

At step 505, STA 115-f may optionally receive a beacon frame. In the present example, the beacon frame may be transmitted using non-ER data rates.

Additionally or alternatively, at step 510, STA 115-f may transmit (e.g., broadcast) a probe request. As described above, the format of the probe request may be based on a variety of factors (e.g., properties of one or more received beacons, power constraints, stored information, etc.).

At step 512, AP 105-d may transmit a directed probe response, which may be formatted using ER data rates (e.g., using a format supported by BSS2). In this example, the directed probe response may contain information about BSS1 (e.g., a BSSID of a non-ER BSS associated with the same AP 105-d). Additionally or alternatively, the directed probe response may contain information about BSS2. At step 514, STA 115-f may transmit an appropriately formatted ACK.

At step 515, AP 105-d may transmit a directed probe response, which may be formatted using non-ER data rates (e.g., using a format supported by BSS1). In this example, the directed probe response may contain information about BSS2 (e.g., a BSSID of an ER BSS associated with the same AP 105-d). At step 517, STA 115-f may transmit an appropriately formatted ACK.

Accordingly, at step 520, STA 115-f may transmit a directed probe request to AP 105-d using a format supported by BSS2 (e.g., based on information in the directed probe response of step 515). At step 522, AP 105-d may transmit an appropriately formatted ACK. At step 525, STA 115-f may receive a probe response from AP 105-d and subsequently send an appropriately formatted ACK at step 527. Accordingly, STA 115-f may initiate an authentication and association procedure with AP 105-d (e.g., to associate with BSS2). The authentication and association procedure, illustrated in steps 530 through 547, may be an example of the corresponding procedure described above with reference to steps 465 through 482 of FIG. 4.

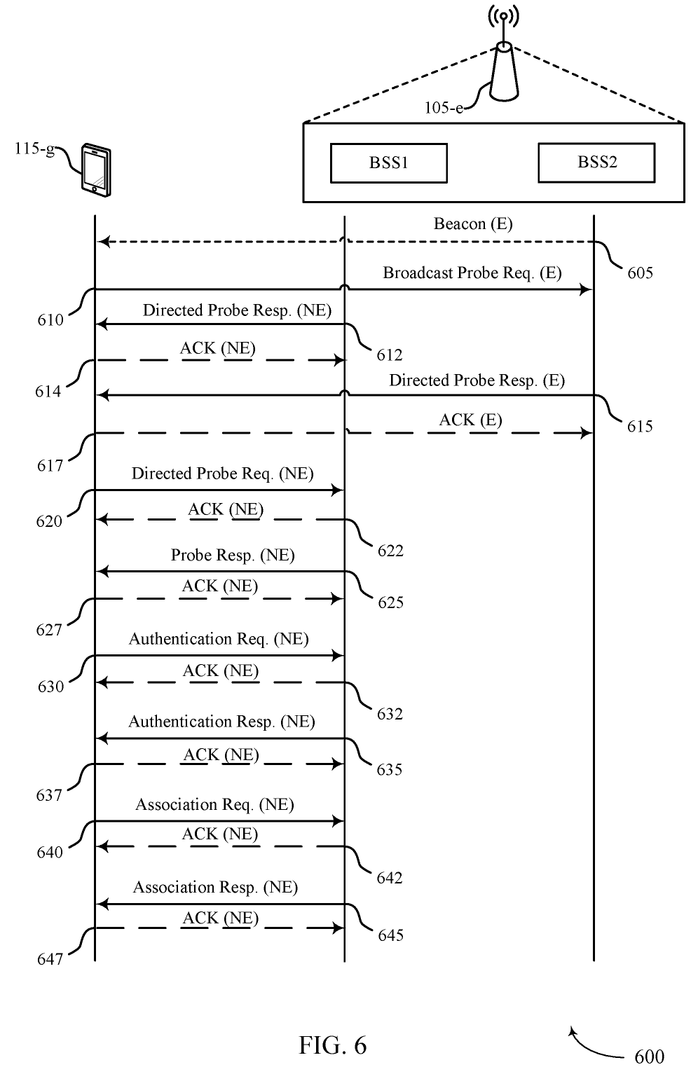

FIG. 6 illustrates an example of a process flow 600 that supports multiple BSSs for ER and/or non-ER operation in accordance with various aspects of the present disclosure. Specifically, FIG. 6 illustrates an example of a process by which a STA 115 may discover and associate with a non-ER BSS. FIG. 6 illustrates a STA 115-g and an AP 105-e, each of which may be an example of the corresponding devices described above. In this example, AP 105-e is illustrated as supporting BSS1 and BSS2, although more than two BSSs may be supported without deviating from the scope of the present disclosure. In the present example, BSS1 may represent a non-ER BSS while BSS2 may represent an ER BSS. Accordingly, referring to FIG. 2, BSS1 may be associated with coverage area 205 while BSS2 may be associated with coverage area 210. In this example, BSS1 may only support transmissions using non-ER data rates while BSS2 may only support transmissions using ER data rates.

At step 605, STA 115-g may optionally receive a beacon frame. In the present example, the beacon frame may be transmitted using ER data rates.

Additionally or alternatively, at step 610, STA 115-g may transmit (e.g., broadcast) a probe request. As described above, the format of the probe request may be based on a variety of factors (e.g., properties of one or more received beacons, power constraints, stored information, etc.).

At step 612, AP 105-e may transmit a directed probe response, which may be formatted using non-ER data rates (e.g., using a format supported by BSS1). In this example, the directed probe response may contain information about BSS2 (e.g., a BSSID of an ER BSS associated with the same AP 105-e). Additionally or alternatively, the directed probe response may contain information about BSS1. At step 614, STA 115-g may transmit an appropriately formatted ACK.

At step 615, AP 105-e may transmit a directed probe response, which may be formatted using ER data rates (e.g., using a format supported by BSS2). In this example, the directed probe response may contain information about BSS1 (e.g., a BSSID of a non-ER BSS associated with the same AP 105-e). At step 617, STA 115-g may transmit an appropriately formatted ACK.

Accordingly, at step 620, STA 115-g may transmit a directed probe request to AP 105-e using a format supported by BSS1 (e.g., based on information in the directed probe response of step 615). At step 622, AP 105-e may transmit an appropriately formatted ACK. At step 625, STA 115-g may receive a probe response from AP 105-e and subsequently send an appropriately formatted ACK at step 627. Accordingly, STA 115-g may initiate an authentication and association procedure with AP 105-e (e.g., to associate with BSS1). The authentication and association procedure, illustrated in steps 630 through 647, may be an example of the corresponding procedure described above with reference to steps 425 through 442 of FIG. 4.

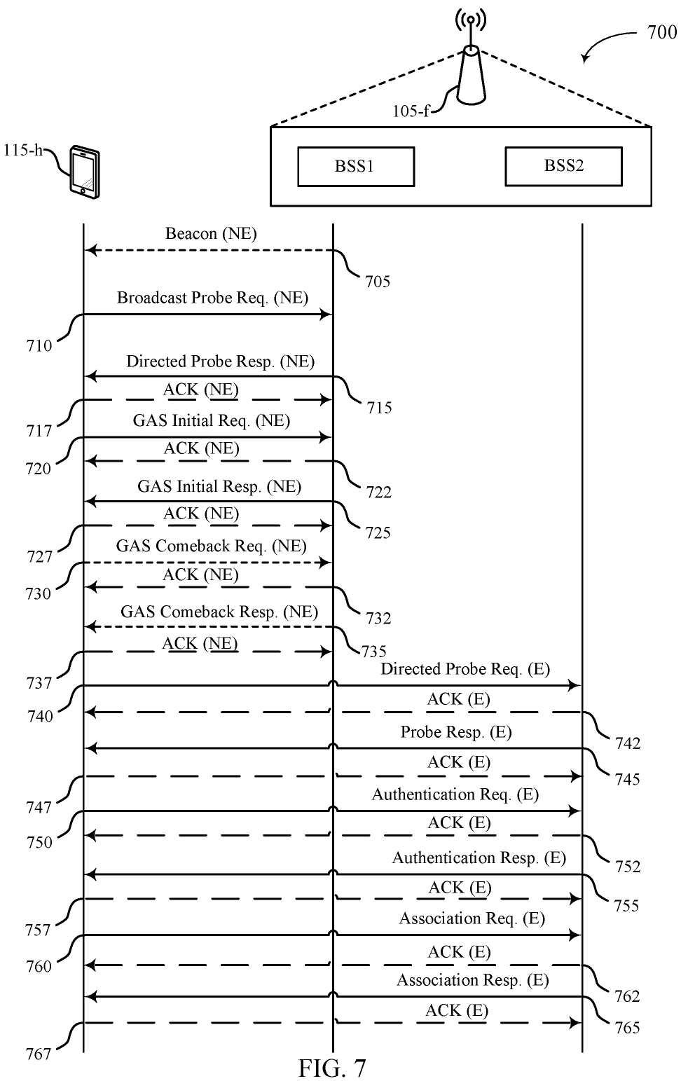

FIG. 7 illustrates an example of a process flow 700 that supports multiple BSSs for ER and/or non-ER operation in accordance with various aspects of the present disclosure. Specifically, FIG. 7 illustrates an example of a process by which a STA 115 may discover and associate with an ER BSS. Process flow 700 includes a STA 115-h and an AP 105-f, each of which may be an example of the corresponding devices described above. In this example, AP 105-f is illustrated as supporting BSS1 and BSS2, although more than two BSSs may be supported without deviating from the scope of the present disclosure. In the present example, BSS1 may represent a non-ER BSS while BSS2 may represent an ER BSS. Accordingly, referring to FIG. 2, BSS1 may be associated with coverage area 205 while BSS2 may be associated with coverage area 210. In this example, BSS1 may only support transmissions using non-ER data rates while BSS2 may only support transmissions using ER data rates.

Aspects of FIG. 7 may resemble corresponding aspects of FIG. 5. As shown, process flow 700 may include extra pre-association communications (e.g., communications not included in FIG. 5). The extra communications may be associated with an ANQP, which may be a query and response protocol used by a STA 115 to discover a range of information useful in the STA 115's network selection process (e.g., internet protocol (IP) address type availability, etc.).

At step 705, STA 115-h may optionally receive a beacon frame. In the present example, the beacon frame may be transmitted using non-ER data rates.

Additionally or alternatively, at step 710, STA 115-h may transmit (e.g., broadcast) a probe request. As described above, the format of the probe request may be based on a variety of factors (e.g., properties of one or more received beacons, power constraints, stored information, etc.).

At step 715, AP 105-f may transmit a directed probe response (e.g., using a format supported by the non-ER BSS). Accordingly, the directed probe response may be formatted using non-ER data rates. In this example, the directed probe response may contain information about BSS2 (e.g., a BSSID of ER BSS associated with the same AP 105-f). At step 717, STA 115-h may transmit an appropriately formatted ACK (e.g., a NE ACK). As discussed above with reference to FIGS. 4 through 6, AP 105-f may in some cases respond to the broadcast probe request with two directed probe responses (e.g., one in a format supported by BSS1 and the other in a format supported by BSS2), and each directed probe response may contain information about one or more BSSs associated with the AP 105-f.

The beacon of step 705 and/or the probe response of step 715 may contain an ANQP vendor information element (IE), which may indicate, for example, that the AP 105-f supports one or more ER BSSs. In this example, the STA 115-h may discover BSS2 (e.g., the BSSID of the ER BSS) using the ANQP vendor IE.

At step 720, STA 115-h may transmit a generic advertisement service (GAS) initial request (e.g., to enable STA 115-h to identify the availability of information related to network services prior to association). At step 722, AP 105-f may transmit an appropriately formatted ACK. At step 725, STA 115-h may receive a GAS initial response, which may include the desired information related to network services and subsequently transmit an appropriately formatted ACK at step 727. In some cases (e.g., in the case that not all desired information is contained in the GAS initial response), STA 115-h may optionally transmit a GAS Comeback request at step 730 and receive a corresponding GAS Comeback response at step 735. In some cases, the GAS Comeback response may set a time for the STA 115-h to resend a query for the desired information (e.g., to transmit another GAS request). GAS Comeback request of step 730 and GAS Comeback response of step 735 may each be followed by a corresponding, appropriately formatted, ACK transmission at steps 732 and 737, respectively.

Steps 740 through 767, which may include the authentication and association procedure, may correspond to steps 520 through 547 of FIG. 5.

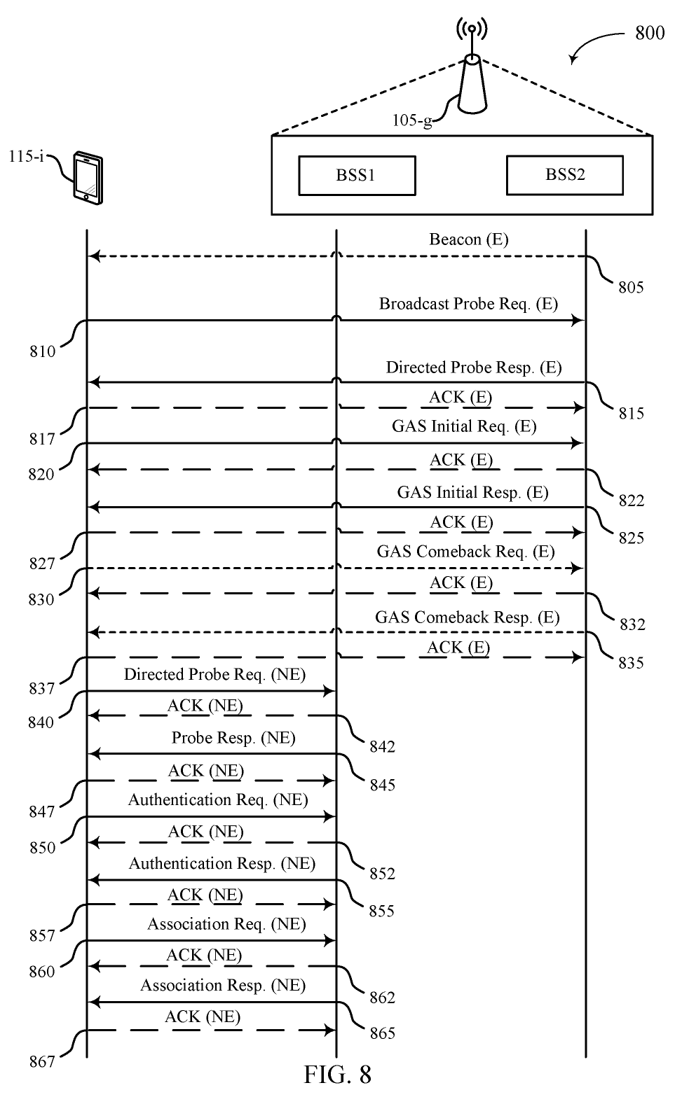

FIG. 8 illustrates an example of a process flow 800 that supports multiple BSSs for ER and/or non-ER operation in accordance with various aspects of the present disclosure. Specifically, FIG. 8 illustrates an example of a process by which a STA 115 may discover and associate with a non-ER BSS. Process flow 800 includes a STA 115-i and an AP 105-g, each of which may be an example of the corresponding devices described above. In this example, AP 105-g is illustrated as supporting BSS1 and BSS2, although more than two BSSs may be supported without deviating from the scope of the present disclosure. In the present example, BSS1 may represent a non-ER BSS while BSS2 may represent an ER BSS. Accordingly, referring to FIG. 2, BSS1 may be associated with coverage area 205 while BSS2 may be associated with coverage area 210. In this example, BSS1 may only support transmissions using non-ER data rates while BSS2 may only support transmissions using ER data rates.

The steps of process flow 800 may be analogous to the corresponding steps of process flow 700, but each transmission may be formatted using the opposite data rate from the corresponding step of process flow 700. As an example, the GAS initial request of step 820 may be formatted using ER data rates, while the GAS initial request of step 720 was formatted using non-ER data rates.

Thus, FIGS. 5 through 8 illustrate example process flows by which a STA 115 may communicate with a first BSS of an AP 105 in order to receive information about a second BSS of the AP 105. In these examples, the two BSSs may have similar properties (e.g., identical security profiles), and may be distinguished based on whether they support non-ER transmissions (e.g., BSS1) or ER transmissions (e.g., BSS2). Thus, in these examples, the non-ER BSS (e.g., BSS1) may transmit information about the presence and properties of an ER BSS with equivalent security in its beacons and probe responses. Alternatively, the ER BSS (e.g., BSS2) may transmit information about the presence and properties of a non-ER BSS with equivalent security in its beacons and probe responses. Using the above procedures, a STA 115 that is far off from an AP 105 can associate with an ER BSS while a second STA 115 that is near to the same AP 105 can associate to a non-ER BSS. In some cases, the association may be based on a variety of conditions (e.g., location information, RSSI of a beacon, etc.). Because transmissions associated with the respective BSSs can be either ER or non-ER (e.g., but not both for a given BSS), characteristics (e.g., efficiency, throughput, etc.) of the wireless system may be improved.

FIG. 9 illustrates a process flow 900 that supports multiple BSSs for ER and/or non-ER operation in accordance with various aspects of the present disclosure. As described above, it may be desirable to allow a STA 115 to switch between an ER BSS and a non-ER BSS (e.g., based on mobility, path loss, data throughput requirements, etc.). Process flow 900 includes a STA 115-j and an AP 105-h, each of which may be an example of the corresponding devices described above. In this example, AP 105-h is illustrated as supporting BSS1 and BSS2, although more than two BSSs may be supported without deviating from the scope of the present disclosure. In the present example, BSS1 may represent a non-ER BSS while BSS2 may represent an ER BSS. Accordingly, referring to FIG. 2, BSS1 may be associated with coverage area 205 while BSS2 may be associated with coverage area 210. In this example, BSS1 may only support transmissions using non-ER data rates while BSS2 may only support transmissions using ER data rates.

In the present example, STA 115-j may have previously associated with a non-ER BSS (e.g., BSS1). At step 905, STA 115-j may optionally transmit a BSS transition message (BTM) query (e.g., in the cast that STA 115-j detects that it is moving away from the AP 105-h, which may be based on RSSI, location information, etc.). In aspects, the BTM query may optionally include a request for a list of candidate target BSSs (e.g., BSSIDs of a transition candidate list). In the present example in which the STA 115-j is associated with a non-ER BSS, the candidate list may contain a BSSID of an ER BSS (e.g., which may have an equivalent security profile). In some cases, the BTM query may represent a means for STA 115-j to request a neighbor report (e.g., in case the STA 115-j does not know information about alternative BSSs).

At step 910, AP 105-h may transmit a BTM request. In some cases, the BTM request may be transmitted in response to a BTM query. Alternatively, the AP 105-h may transmit the BTM request without receiving a BTM query (e.g., in the case that the AP 105-h detects that the STA 115-j is moving away). Although described as being in response to movement of the STA 115-j, the switch between BSSs may be in response to a variety of factors (e.g., the number of devices associated with a given BSS, network conditions, etc.). The BTM request may include a neighbor report element, which may contain information related to an ER BSS with an equivalent security profile that the STA 115-j can switch to or use to roam.

At step 915, STA 115-j may transmit a BTM response. In aspects, the BTM response may include a status indication as well as a target BSS (e.g., BSS2 in the present example). In some cases, MBO reason code and cellular steering extensions may be used (e.g., if the STA 115-j and the AP 105-h are MBO certified).

FIG. 10 illustrates a process flow 1000 that supports multiple BSSs for ER and/or non-ER operation in accordance with various aspects of the present disclosure. As described above, it may be desirable to allow a STA 115 to switch between an ER BSS and a non-ER BSS (e.g., based on mobility, path loss, data throughput requirements, etc.). Process flow 1000 includes a STA 115-k and an AP 105-i, each of which may be an example of the corresponding devices described above. In this example, AP 105-i is illustrated as supporting BSS1 and BSS2, although more than two BSSs may be supported without deviating from the scope of the present disclosure. In the present example, BSS1 may represent a non-ER BSS while BSS2 may represent an ER BSS. Accordingly, referring to FIG. 2, BSS1 may be associated with coverage area 205 while BSS2 may be associated with coverage area 210. In this example, BSS1 may only support transmissions using non-ER data rates while BSS2 may only support transmissions using ER data rates.

The steps of process flow 1000 may be analogous to the corresponding steps of process flow 900, but each transmission may be formatted using the opposite data rate from the corresponding step of process flow 900. As an example, the BTM request of step 1010 may be formatted using ER data rates, while the BTM request of step 910 may have been formatted using non-ER data rates.

Thus, FIGS. 9 and 10 illustrate example process flows by which a STA 115 may switch between communicating with a first BSS of an AP 105 to communicating with a second BSS of the AP 105. Using the above procedures, a STA 115 that is, e.g., moving away from an AP 105 can switch to an ER BSS while a second STA 115 that is moving closer to the same AP 105 can switch to a non-ER BSS. In some cases, the switch may be based on a variety of conditions (e.g., location information, RSSI of a beacon, etc.). Although illustrated as switching between two BSSs of the same AP 105, it may be possible for a given STA 115 to switch between a BSS of one AP 105 to a BSS of a second AP 105. Thus, a switch need not necessarily occur between an ER BSS and a non-ER BSS (e.g., a STA 115 may switch between an ER BSS of one AP 105 and an ER BSS of a second AP 105). In some cases, the first and second AP may be members of the same ESS. Alternatively, they may be associated with different ESSs.

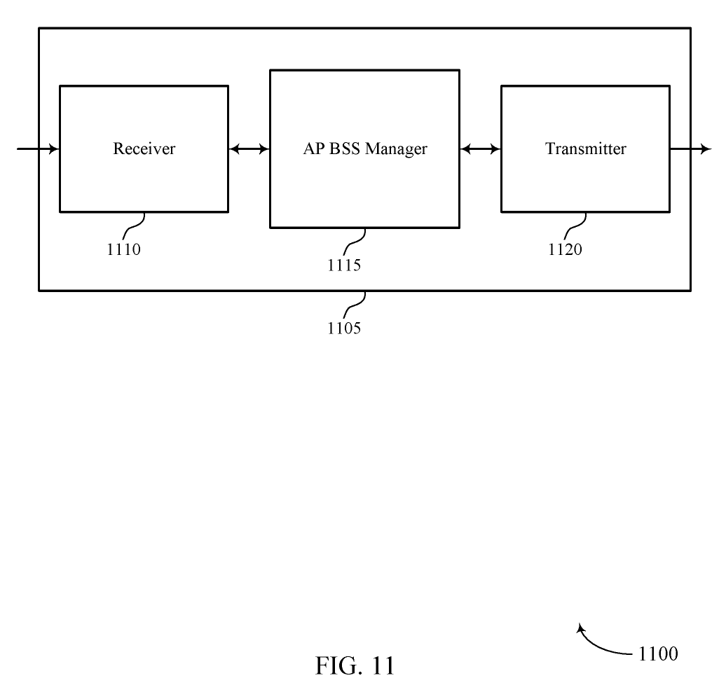

FIG. 11 shows a block diagram 1100 of a wireless device 1105 that supports multiple basic service sets for ER operation in accordance with various aspects of the present disclosure. Wireless device 1105 may be an example of aspects of AP 105 as described with reference to FIG. 1. Wireless device 1105 may include receiver 1110, AP BSS manager 1115, and transmitter 1120. Wireless device 1105 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

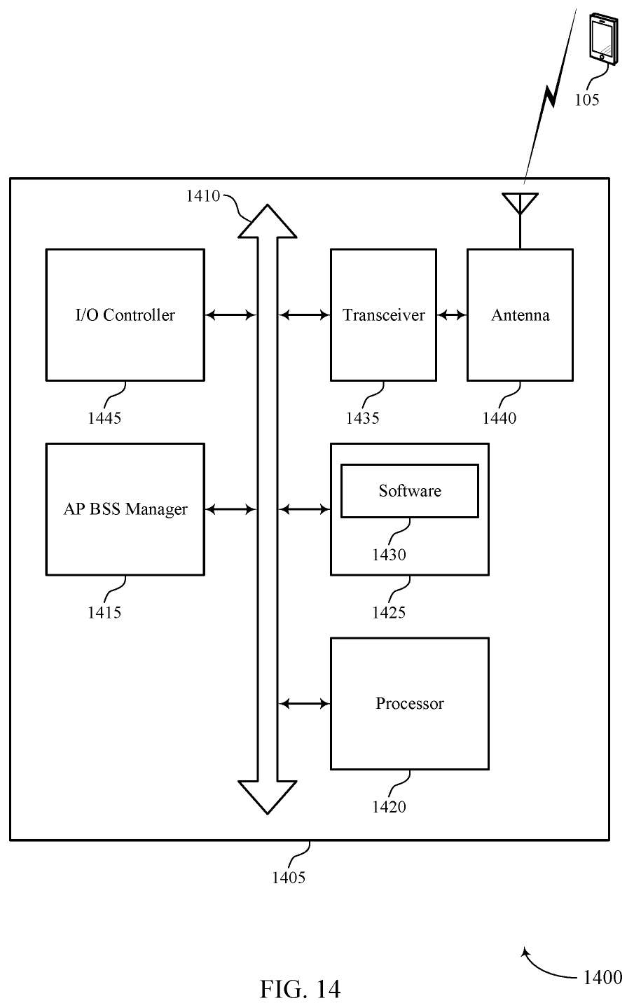

Receiver 1110 may receive information such as packets, user data, or control information associated with various information channels (e.g., control channels, data channels, and information related to multiple basic service sets for ER operation, etc.). Information may be passed on to other components of the device. The receiver 1110 may be an example of aspects of the transceiver 1435 described with reference to FIG. 14.

AP BSS manager 1115 may be an example of aspects of the AP BSS manager 1415 described with reference to FIG. 14. AP BSS manager 1115 and/or at least some of its various sub-components may be implemented in hardware, software executed by a processor, firmware, or any combination thereof If implemented in software executed by a processor, the functions of the AP BSS manager 1115 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The AP BSS manager 1115 and/or at least some of its various sub-components may be physically located at various positions, including being distributed such that portions of functions are implemented at different physical locations by one or more physical devices. In some examples, AP BSS manager 1115 and/or at least some of its various sub-components may be a separate and distinct component in accordance with various aspects of the present disclosure. In other examples, AP BSS manager 1115 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

AP BSS manager 1115 may receive a wireless communication from a station, identify that the wireless communication is formatted according to the ER transmission mode or one of the one or more non-ER transmission modes, and perform an association and authentication procedure with the station to establish: a first communication link of the first BSS between the AP and the station based on identifying that the wireless communication is formatted according to the ER transmission mode, or a second communication link of the second BSS between the AP and the station based on identifying that the wireless communication is formatted according to the non-ER transmission mode. The AP BSS manager 1115 may also receive, from a station, a probe request identifying a first BSS and formatted according to a transmission mode, the transmission mode including an ER transmission mode or one or more second transmission modes. The AP may be configured to support a set of BSSs, including the first BSS and a second BSS, one of the first BSS or the second BSS to communicate using the ER transmission mode, and a different one of the first BSS or the second BSS to communicate using one or more second transmission modes. The AP may transmit, to the station, an identifier of the second BSS in a probe response formatted according to the transmission mode, and receive, from the station, a request of an association and authentication procedure based on the identifier of the second BSS.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1435 described with reference to FIG. 14. The transmitter 1120 may include a single antenna, or it may include a set of antennas.

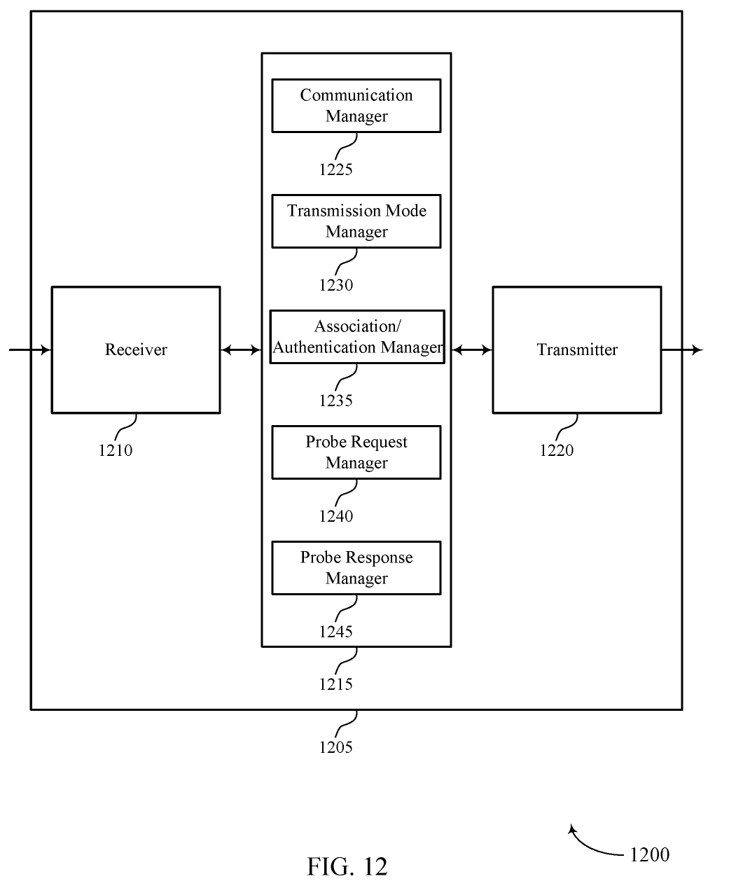

FIG. 12 shows a block diagram 1200 of a wireless device 1205 that supports multiple basic service sets for ER operation in accordance with various aspects of the present disclosure. Wireless device 1205 may be an example of aspects of a wireless device 1105 or an AP 105 as described with reference to FIGS. 1 and 11. Wireless device 1205 may include receiver 1210, AP BSS manager 1215, and transmitter 1220. Wireless device 1205 may also include a processor. Each of these components may be in communication with one another (e.g., via one or more buses).

Receiver 1210 may receive information such as packets, user data, or control information associated with various information channels (e.g., control channels, data channels, and information related to multiple basic service sets for ER operation, etc.). Information may be passed on to other components of the device. The receiver 1210 may be an example of aspects of the transceiver 1435 described with reference to FIG. 14.

AP BSS manager 1215 may be an example of aspects of the AP BSS manager 1415 described with reference to FIG. 14. AP BSS manager 1215 may also include communication manager 1225, transmission mode manager 1230, association/authentication manager 1235, probe request manager 1240, and probe response manager 1245.

Communication manager 1225 may receive a wireless communication from a station. Transmission mode manager 1230 may identify that the wireless communication is formatted according to the ER transmission mode or one of the one or more non-ER transmission modes. In some cases, the first BSS is used by the AP for exclusive communication of data, control, and management frames formatted according to the ER transmission mode. In some cases, the second BSS is used by the AP for communication of data, control, and management frames formatted according to the one or more non-ER transmission modes. In some cases, the first BSS is an ER BSS and the second BSS is a non-ER BSS. In some cases, the first BSS is associated with a first BSS identifier and the second BSS is associated with a second BSS identifier, the first BSS identifier different from the second BSS identifier. In some cases, the first communication link of the first BSS and the second communication link of the second BSS are associated with same operating channels. In some cases, the first communication link of the first BSS and the second communication link of the second BSS are associated with different operating channels.

Association/authentication manager 1235 may perform an association and authentication procedure with the station to establish: a first communication link of the first BSS between the AP and the station based on identifying that the wireless communication is formatted according to the ER transmission mode, or a second communication link of the second BSS between the AP and the station based on identifying that the wireless communication is formatted according to the non-ER transmission mode. Association/authentication manager 1235 may receive, from the station, a request of an association and authentication procedure based on the identifier of the second BSS (BSSID).

Probe request manager 1240 may receive, from a station, a probe request identifying a first BSS and formatted according to a transmission mode, the transmission mode including an ER transmission mode or one or more second transmission modes. The AP may be configured to support a set of BSSs, including the first BSS and a second BSS, one of the first BSS or the second BSS to communicate using the ER transmission mode, and a different one of the first BSS or the second BSS to communicate using one or more second transmission modes. Probe request manager 1240 may identify that the probe request is formatted according to the first transmission mode. In some cases, the first BSS and the second BSS have an equivalent security profile.

Probe response manager 1245 may transmit, to the station, an identifier of the second BSS in a probe response formatted according to the transmission mode and refrain from transmitting a probe response based on the identification. In some cases, the probe response includes a BSS identifier associated with the first BSS or the second BSS.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1435 described with reference to FIG. 14. The transmitter 1220 may include a single antenna, or it may include a set of antennas.

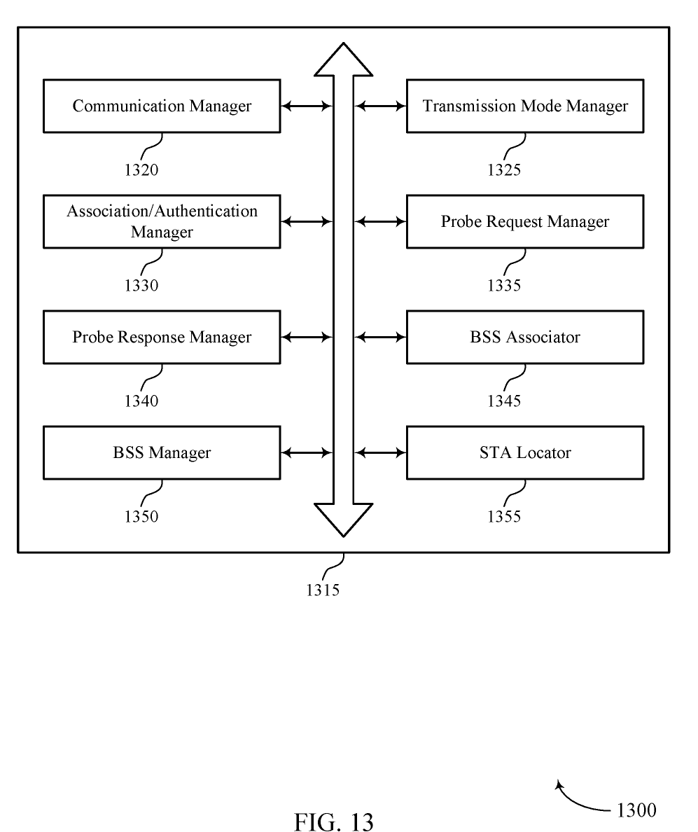

FIG. 13 shows a block diagram 1300 of an AP BSS manager 1315 that supports multiple basic service sets for ER operation in accordance with various aspects of the present disclosure. The AP BSS manager 1315 may be an example of aspects of AP BSS manager 1115, AP BSS manager 1215, or AP BSS manager 1415 described with reference to FIGS. 11, 12, and 14, respectively. The AP BSS manager 1315 may include communication manager 1320, transmission mode manager 1325, association/authentication manager 1330, probe request manager 1335, probe response manager 1340, BSS associator 1345, BSS manager 1350, and STA locator 1355. Each of these modules may communicate, directly or indirectly, with one another (e.g., via one or more buses).

Communication manager 1320 may receive a wireless communication from a station.

Transmission mode manager 1325 may identify that the wireless communication is formatted according to the ER transmission mode or one of the one or more non-ER transmission modes. In some cases, the first BSS is used by the AP for exclusive communication of data, control, and management frames formatted according to the ER transmission mode. In some cases, the second BSS is used by the AP for communication of data, control, and management frames formatted according to the one or more non-ER transmission modes. In some cases, the first BSS is an ER BSS and the second BSS is a non-ER BSS. In some cases, the first BSS is associated with a first BSS identifier and the second BSS is associated with a second BSS identifier, the first BSS identifier different from the second BSS identifier. In some cases, the first communication link of the first BSS and the second communication link of the second BSS are associated with same operating channels. In some cases, the first communication link of the first BSS and the second communication link of the second BSS are associated with different operating channels.

Association/authentication manager 1330 may perform an association and authentication procedure with the station to establish: a first communication link of the first BSS between the AP and the station based on identifying that the wireless communication is formatted according to the ER transmission mode, or a second communication link of the second BSS between the AP and the station based on identifying that the wireless communication is formatted according to the non-ER transmission mode. Association/authentication manager 1330 may receive, from the station, a request of an association and authentication procedure based on the identifier of the second BSS.

Probe request manager 1335 may receive, from a station, a probe request identifying a first BSS and formatted according to a transmission mode, the transmission mode including an ER transmission mode or one or more second transmission modes. The AP may be configured to support a set of BSSs, including the first BSS and a second BSS, one of the first BSS or the second BSS to communicate using the ER transmission mode, and a different one of the first BSS or the second BSS to communicate using one or more second transmission modes. Probe request manager 1335 may identify that the probe request is formatted according to the first transmission mode. In some cases, the first BSS and the second BSS have an equivalent security profile.

Probe response manager 1340 may transmit, to the station, an identifier of the second BSS in a probe response formatted according to the transmission mode and refrain from transmitting a probe response based on the identification. In some cases, the probe response includes a BSS identifier associated with the first BSS or the second BSS.

BSS associator 1345 may associate the station with the second BSS. BSS manager 1350 may transmit, to the station, a request for the station to move from being associated with the second BSS to being associated with the first BSS and transmit a list of candidate target BSSs to the station based on the identification. STA locator 1355 may identify a change in location of the station.

FIG. 14 shows a diagram of a system 1400 including a device 1405 that supports multiple basic service sets for ER operation in accordance with various aspects of the present disclosure. Device 1405 may be an example of or include the components of wireless device 1105, wireless device 1205, or an AP 105 as described above, e.g., with reference to FIGS. 1, 11 and 12. Device 1405 may include components for bi-directional voice and data communications including components for transmitting and receiving communications, including AP BSS manager 1415, processor 1420, memory 1425, software 1430, transceiver 1435, antenna 1440, and I/O controller 1445. These components may be in electronic communication via one or more busses (e.g., bus 1410).

Processor 1420 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1420 may be configured to operate a memory array using a memory controller. In other cases, a memory controller may be integrated into processor 1420. Processor 1420 may be configured to execute computer-readable instructions stored in a memory to perform various functions (e.g., functions or tasks supporting multiple basic service sets for ER operation).

Memory 1425 may include random access memory (RAM) and read only memory (ROM). The memory 1425 may store computer-readable, computer-executable software 1430 including instructions that, when executed, cause the processor to perform various functions described herein. In some cases, the memory 1425 may contain, among other things, a basic input/output system (BIOS) which may control basic hardware and/or software operation such as the interaction with peripheral components or devices.

Software 1430 may include code to implement aspects of the present disclosure, including code to support multiple basic service sets for ER operation. Software 1430 may be stored in a non-transitory computer-readable medium such as system memory or other memory. In some cases, the software 1430 may not be directly executable by the processor but may cause a computer (e.g., when compiled and executed) to perform functions described herein.

Transceiver 1435 may communicate bi-directionally, via one or more antennas, wired, or wireless links as described above. For example, the transceiver 1435 may represent a wireless transceiver and may communicate bi-directionally with another wireless transceiver. The transceiver 1435 may also include a modem to modulate the packets and provide the modulated packets to the antennas for transmission, and to demodulate packets received from the antennas.

In some cases, the wireless device may include a single antenna 1440. However, in some cases the device may have more than one antenna 1440, which may be capable of concurrently transmitting or receiving multiple wireless transmissions.

I/O controller 1445 may manage input and output signals for device 1405. I/O controller 1445 may also manage peripherals not integrated into device 1405. In some cases, I/O controller 1445 may represent a physical connection or port to an external peripheral. In some cases, I/O controller 1445 may utilize an operating system such as iOS®, ANDROID®, MS-DOS®, MS-WINDOWS®, OS/2®, UNIX®, LINUX®, or another known operating system. In other cases, I/O controller 1445 may represent or interact with a modem, a keyboard, a mouse, a touchscreen, or a similar device. In some cases, I/O controller 1445 may be implemented as part of a processor. In some cases, a user may interact with device 1405 via I/O controller 1445 or via hardware components controlled by I/O controller 1445.

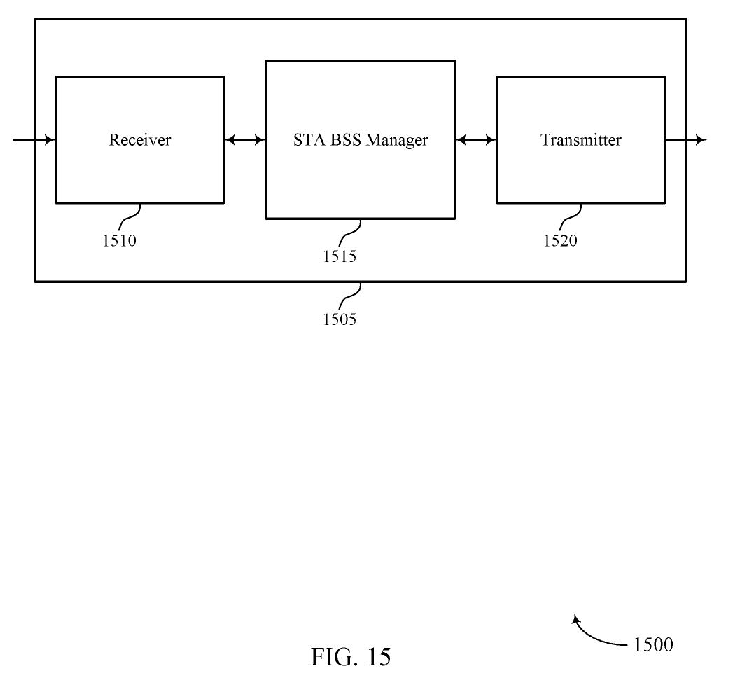

FIG. 15 shows a block diagram 1500 of a wireless device 1505 that supports multiple basic service sets for ER operation in accordance with various aspects of the present disclosure. Wireless device 1505 may be an example of aspects of a STA 115 as described with reference to FIG. 1. Wireless device 1505 may include receiver 1510, STA BSS manager 1515, and transmitter 1520. Wireless device 1505 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

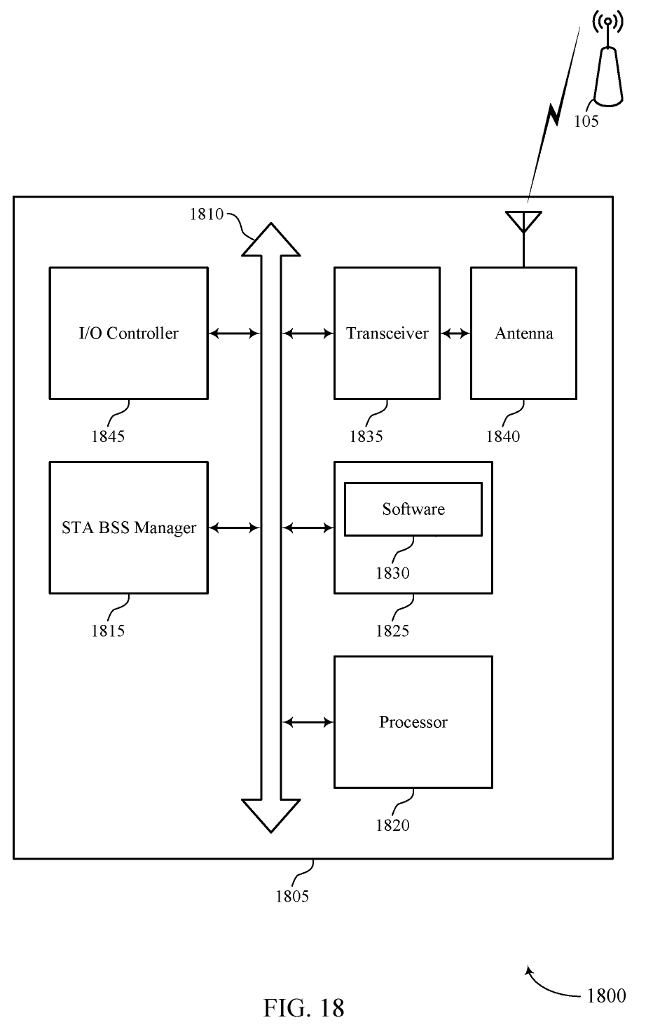

Receiver 1510 may receive information such as packets, user data, or control information associated with various information channels (e.g., control channels, data channels, and information related to multiple basic service sets for ER operation, etc.). Information may be passed on to other components of the device. The receiver 1510 may be an example of aspects of the transceiver 1835 described with reference to FIG. 18.

STA BSS manager 1515 may be an example of aspects of the STA BSS manager 1815 described with reference to FIG. 18. STA BSS manager 1515 and/or at least some of its various sub-components may be implemented in hardware, software executed by a processor, firmware, or any combination thereof If implemented in software executed by a processor, the functions of the STA BSS manager 1515 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The STA BSS manager 1515 and/or at least some of its various sub-components may be physically located at various positions, including being distributed such that portions of functions are implemented at different physical locations by one or more physical devices. In some examples, STA BSS manager 1515 and/or at least some of its various sub-components may be a separate and distinct component in accordance with various aspects of the present disclosure. In other examples, STA BSS manager 1515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

STA BSS manager 1515 may transmit a probe request formatted according to a transmission mode, the transmission mode including an ER transmission mode or one or more second transmission modes. STA BSS manager 1515 may receive, from an AP, a probe response formatted according to the transmission mode, identify a supported data rate associated with (e.g., specified in) the probe response, and determine to associate with one of a first BSS or a second BSS supported by the AP based on the received probe response and the identified supported data rate, the first BSS configured to communicate using one of the ER transmission mode or the one or more second transmission modes, and the second BSS configured to communicate using a different one of the ER transmission mode or the one or more second transmission modes. In some cases, the probe response includes a BSS identifier associated with the first BSS or the second BSS.

Transmitter 1520 may transmit signals generated by other components of the device. In some examples, the transmitter 1520 may be collocated with a receiver 1510 in a transceiver module. For example, the transmitter 1520 may be an example of aspects of the transceiver 1835 described with reference to FIG. 18. The transmitter 1520 may include a single antenna, or it may include a set of antennas.

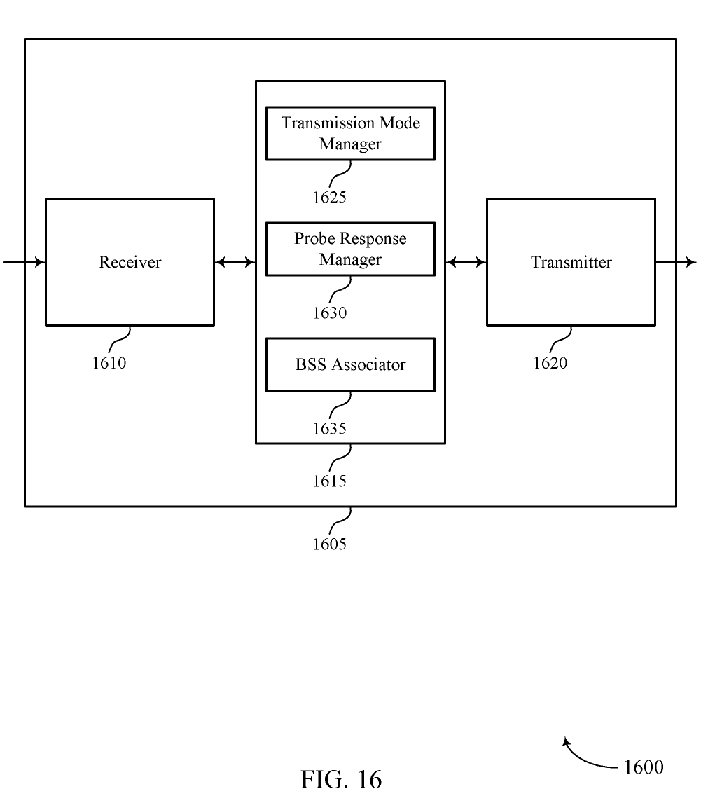

FIG. 16 shows a block diagram 1600 of a wireless device 1605 that supports multiple basic service sets for ER operation in accordance with various aspects of the present disclosure. Wireless device 1605 may be an example of aspects of a wireless device 1505 or a STA 115 as described with reference to FIGS. 1 and 15. Wireless device 1605 may include receiver 1610, STA BSS manager 1615, and transmitter 1620. Wireless device 1605 may also include a processor. Each of these components may be in communication with one another (e.g., via one or more buses).

Receiver 1610 may receive information such as packets, user data, or control information associated with various information channels (e.g., control channels, data channels, and information related to multiple basic service sets for ER operation, etc.). Information may be passed on to other components of the device. The receiver 1610 may be an example of aspects of the transceiver 1835 described with reference to FIG. 18. STA BSS manager 1615 may be an example of aspects of the STA BSS manager 1815 described with reference to FIG. 18. STA BSS manager 1615 may also include transmission mode manager 1625, probe response manager 1630, and BSS associator 1635.

Transmission mode manager 1625 may transmit a probe request formatted according to a transmission mode, the transmission mode including an ER transmission mode or one or more second transmission modes.

Probe response manager 1630 may receive, from an AP, a probe response formatted according to the transmission mode, identify a supported data rate specified in the probe response, and receive the probe response from the AP based on the transmission mode format associated with the probe request. In some cases, the probe response includes a BSS identifier associated with the first BSS or the second BSS.

BSS associator 1635 may determine to associate with one of a first BSS or a second BSS supported by the AP based on the received probe response and the identified supported data rate, the first BSS configured to communicate using one of the ER transmission mode or the one or more second transmission modes, and the second BSS configured to communicate using a different one of the ER transmission mode or the one or more second transmission modes. BSS associator 1635 may determine to associate with the second BSS based on the received indication or determine to associate with the one of the first BSS or the second BSS based on the received probe response, the identified signal strength, the identified location, and a supported transmission mode for communication in the second BSS. BSS associator 1635 may associate with the determined one of the first BSS or the second BSS. In some cases, the first BSS and the second BSS have an equivalent security profile. In some cases, BSS associator 1635 may determine to associate with the first BSS or the second BSS based at least in part on the received probe response, the identified location, proximity, or some combination thereof; and a transmission mode supported by the second BSS.

Transmitter 1620 may transmit signals generated by other components of the device. In some examples, the transmitter 1620 may be collocated with a receiver 1610 in a transceiver module. For example, the transmitter 1620 may be an example of aspects of the transceiver 1835 described with reference to FIG. 18. The transmitter 1620 may include a single antenna, or it may include a set of antennas.

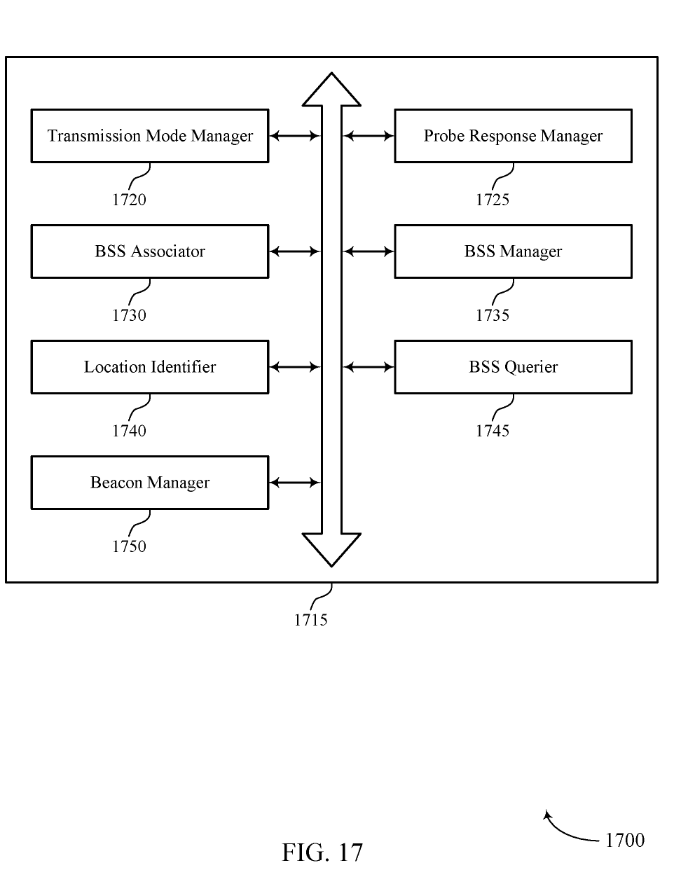

FIG. 17 shows a block diagram 1700 of a STA BSS manager 1715 that supports multiple basic service sets for ER operation in accordance with various aspects of the present disclosure. The STA BSS manager 1715 may be an example of aspects of a STA BSS manager 1815 described with reference to FIGS. 15, 16, and 18. The STA BSS manager 1715 may include transmission mode manager 1720, probe response manager 1725, BSS associator 1730, BSS manager 1735, location identifier 1740, BSS querier 1745, and beacon manager 1750. Each of these modules may communicate, directly or indirectly, with one another (e.g., via one or more buses).

Transmission mode manager 1720 may transmit a probe request formatted according to a transmission mode, the transmission mode including an ER transmission mode or one or more second transmission modes.

Probe response manager 1725 may receive, from an AP, a probe response formatted according to the transmission mode, identify a supported data rate specified in the probe response, and receive the probe response from the AP based on the transmission mode format associated with the probe request. In some cases, the probe response includes a BSS identifier associated with the first BSS or the second BSS.

BSS associator 1730 may determine to associate with one of a first BSS or a second BSS supported by the AP based on the received probe response and the identified supported data rate, the first BSS configured to communicate using one of the ER transmission mode or the one or more second transmission modes, and the second BSS configured to communicate using a different one of the ER transmission mode or the one or more second transmission modes. BSS associator 1730 may determine to associate with the second BSS based on the received indication or determine to associate with the one of the first BSS or the second BSS based on the received probe response, the identified signal strength, the identified location, and a supported transmission mode for communication in the second BSS. BSS associator 1730 may associate with the determined one of the first BSS or the second BSS. In some cases, the first BSS and the second BSS have an equivalent security profile. In some cases, BSS associator 1730 may determine to associate with the first BSS or the second BSS based at least in part on the received probe response, the identified location, proximity, or some combination thereof; and a transmission mode supported by the second BSS.

BSS manager 1735 may receive, in the probe response from the first BSS of the AP, an indication of the second BSS based on a transmission mode supported by the second BSS, the indication received in the probe response, receive, from the AP, a request to move to being associated with a different one of the first BSS or the second BSS based on a transmission mode supported by the second BSS, and receive a query response including one or more candidate target BSSs of the AP.

Location identifier 1740 may identify a change in location of the station and identify a location of the station with reference to the AP, a proximity of the station with reference to the AP, or some combination thereof. BSS querier 1745 may transmit a query to the access point for a list of candidate target BSSs based on the change in location and a transmission mode supported by the second BSS. Beacon manager 1750 may receive a beacon from the AP and identify signal strength associated with the received beacon.

FIG. 18 shows a diagram of a system 1800 including a device 1805 that supports multiple basic service sets for ER operation in accordance with various aspects of the present disclosure. Device 1805 may be an example of or include the components of STA 115 as described above, e.g., with reference to FIG. 1. Device 1805 may include components for bi-directional voice and data communications including components for transmitting and receiving communications, including STA BSS manager 1815, processor 1820, memory 1825, software 1830, transceiver 1835, antenna 1840, and I/O controller 1845. These components may be in electronic communication via one or more busses (e.g., bus 1810).

Processor 1820 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1820 may be configured to operate a memory array using a memory controller. In other cases, a memory controller may be integrated into processor 1820. Processor 1820 may be configured to execute computer-readable instructions stored in a memory to perform various functions (e.g., functions or tasks supporting multiple basic service sets for ER operation).

Memory 1825 may include RAM and ROM. The memory 1825 may store computer-readable, computer-executable software 1830 including instructions that, when executed, cause the processor to perform various functions described herein. In some cases, the memory 1825 may contain, among other things, a BIOS which may control basic hardware and/or software operation such as the interaction with peripheral components or devices.

Software 1830 may include code to implement aspects of the present disclosure, including code to support multiple basic service sets for ER operation. Software 1830 may be stored in a non-transitory computer-readable medium such as system memory or other memory. In some cases, the software 1830 may not be directly executable by the processor but may cause a computer (e.g., when compiled and executed) to perform functions described herein.

Transceiver 1835 may communicate bi-directionally, via one or more antennas, wired, or wireless links as described above. For example, the transceiver 1835 may represent a wireless transceiver and may communicate bi-directionally with another wireless transceiver. The transceiver 1835 may also include a modem to modulate the packets and provide the modulated packets to the antennas for transmission, and to demodulate packets received from the antennas.

In some cases, the wireless device may include a single antenna 1840. However, in some cases the device may have more than one antenna 1840, which may be capable of concurrently transmitting or receiving multiple wireless transmissions.

I/O controller 1845 may manage input and output signals for device 1805. I/O controller 1845 may also manage peripherals not integrated into device 1805. In some cases, I/O controller 1845 may represent a physical connection or port to an external peripheral. In some cases, I/O controller 1845 may utilize an operating system such as iOS®, ANDROID®, MS-DOS®, MS-WINDOWS®, OS/2®, UNIX®, LINUX®, or another known operating system. In other cases, I/O controller 1845 may represent or interact with a modem, a keyboard, a mouse, a touchscreen, or a similar device. In some cases, I/O controller 1845 may be implemented as part of a processor. In some cases, a user may interact with device 1805 via I/O controller 1845 or via hardware components controlled by I/O controller 1845.

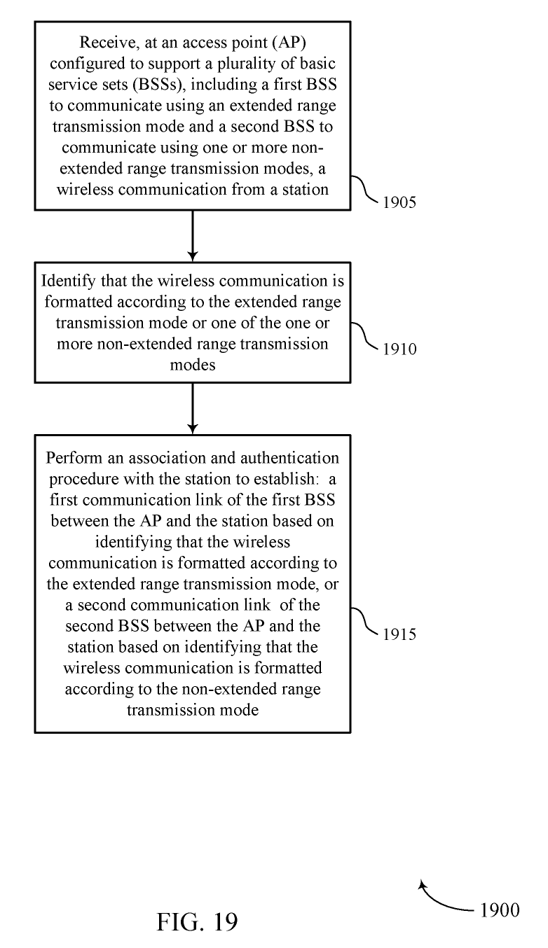

FIG. 19 shows a flowchart illustrating a method 1900 for multiple basic service sets for ER operation in accordance with various aspects of the present disclosure. The operations of method 1900 may be implemented by an AP 105 or its components as described herein. For example, the operations of method 1900 may be performed by an AP BSS manager as described with reference to FIGS. 11 through 14. In some examples, an AP 105 may execute a set of codes to control the functional elements of the device to perform the functions described below. Additionally or alternatively, the AP 105 may perform aspects of the functions described below using special-purpose hardware.

At block 1905 the AP 105 may receive a wireless communication from a station. The operations of block 1905 may be performed according to the methods described with reference to FIGS. 1 through 10. In certain examples, aspects of the operations of block 1905 may be performed by a communication manager as described with reference to FIGS. 11 through 14.

At block 1910 the AP 105 may identify that the wireless communication is formatted according to the ER transmission mode or one of the one or more non-ER transmission modes. The operations of block 1910 may be performed according to the methods described with reference to FIGS. 1 through 10. In certain examples, aspects of the operations of block 1910 may be performed by a transmission mode manager as described with reference to FIGS. 11 through 14.

At block 1915 the AP 105 may perform an association and authentication procedure with the station to establish: a first communication link of the first BSS between the AP and the station based at least in part on identifying that the wireless communication is formatted according to the ER transmission mode, or a second communication link of the second BSS between the AP and the station based at least in part on identifying that the wireless communication is formatted according to the non-ER transmission mode. The operations of block 1915 may be performed according to the methods described with reference to FIGS. 1 through 10. In certain examples, aspects of the operations of block 1915 may be performed by an association/authentication manager as described with reference to FIGS. 11 through 14.

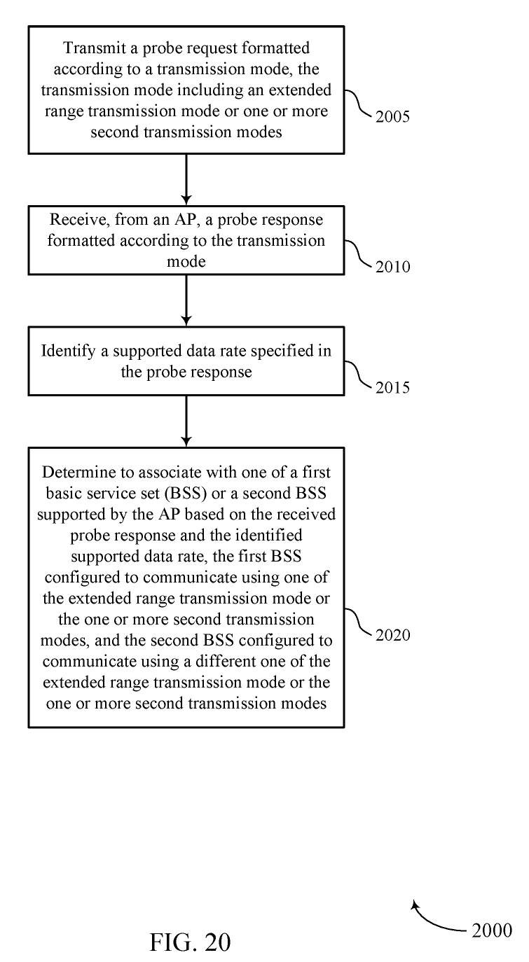

FIG. 20 shows a flowchart illustrating a method 2000 for multiple basic service sets for ER operation in accordance with various aspects of the present disclosure. The operations of method 2000 may be implemented by a STA 115 or its components as described herein. For example, the operations of method 2000 may be performed by a STA BSS manager as described with reference to FIGS. 15 through 18. In some examples, a STA 115 may execute a set of codes to control the functional elements of the device to perform the functions described below. Additionally or alternatively, the STA 115 may perform aspects of the functions described below using special-purpose hardware.

At block 2005 the STA 115 may transmit a probe request formatted according to a transmission mode, the transmission mode comprising an ER transmission mode or one or more second transmission modes. The operations of block 2005 may be performed according to the methods described with reference to FIGS. 1 through 10. In certain examples, aspects of the operations of block 2005 may be performed by a transmission mode manager as described with reference to FIGS. 15 through 18.

At block 2010 the STA 115 may receive, from an AP, a probe response formatted according to the transmission mode. The operations of block 2010 may be performed according to the methods described with reference to FIGS. 1 through 10. In certain examples, aspects of the operations of block 2010 may be performed by a probe response manager as described with reference to FIGS. 15 through 18.

At block 2015 the STA 115 may identify a supported data rate specified in the probe response. The operations of block 2015 may be performed according to the methods described with reference to FIGS. 1 through 10. In certain examples, aspects of the operations of block 2015 may be performed by a probe response manager as described with reference to FIGS. 15 through 18.

At block 2020 the STA 115 may determine to associate with one of a first BSS or a second BSS supported by the AP based at least in part on the received probe response and the identified supported data rate, the first BSS configured to communicate using one of the ER transmission mode or the one or more second transmission modes, and the second BSS configured to communicate using a different one of the ER transmission mode or the one or more second transmission modes. The operations of block 2020 may be performed according to the methods described with reference to FIGS. 1 through 10. In certain examples, aspects of the operations of block 2020 may be performed by a BSS associator as described with reference to FIGS. 15 through 18.

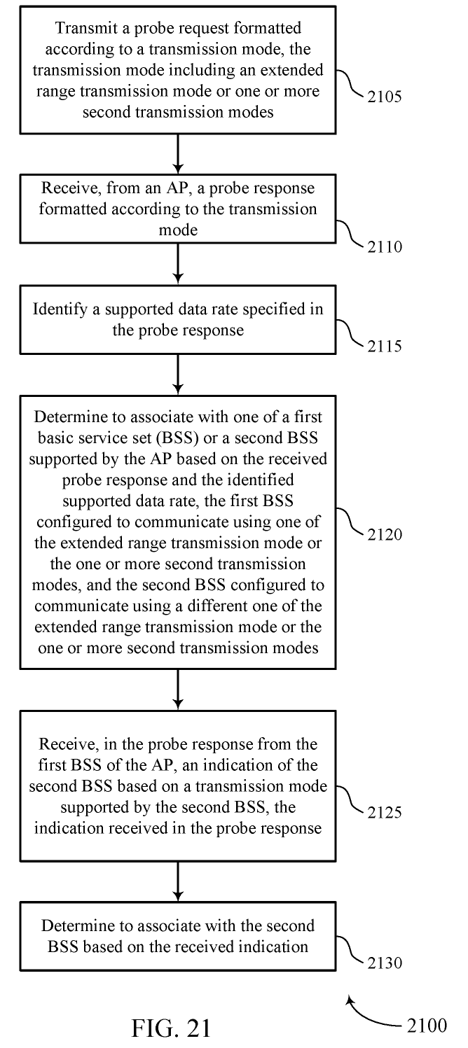

FIG. 21 shows a flowchart illustrating a method 2100 for multiple basic service sets for ER operation in accordance with various aspects of the present disclosure. The operations of method 2100 may be implemented by a STA 115 or its components as described herein. For example, the operations of method 2100 may be performed by a STA BSS manager as described with reference to FIGS. 15 through 18. In some examples, a STA 115 may execute a set of codes to control the functional elements of the device to perform the functions described below. Additionally or alternatively, the STA 115 may perform aspects of the functions described below using special-purpose hardware.

At block 2105 the STA 115 may transmit a probe request formatted according to a transmission mode, the transmission mode comprising an ER transmission mode or one or more second transmission modes. The operations of block 2105 may be performed according to the methods described with reference to FIGS. 1 through 10. In certain examples, aspects of the operations of block 2105 may be performed by a transmission mode manager as described with reference to FIGS. 15 through 18.

At block 2110 the STA 115 may receive, from an AP, a probe response formatted according to the transmission mode. The operations of block 2110 may be performed according to the methods described with reference to FIGS. 1 through 10. In certain examples, aspects of the operations of block 2110 may be performed by a probe response manager as described with reference to FIGS. 15 through 18.

At block 2115 the STA 115 may identify a supported data rate specified in the probe response. The operations of block 2115 may be performed according to the methods described with reference to FIGS. 1 through 10. In certain examples, aspects of the operations of block 2115 may be performed by a probe response manager as described with reference to FIGS. 15 through 18.

At block 2120 the STA 115 may determine to associate with one of a first BSS or a second BSS supported by the AP based at least in part on the received probe response and the identified supported data rate, the first BSS configured to communicate using one of the ER transmission mode or the one or more second transmission modes, and the second BSS configured to communicate using a different one of the ER transmission mode or the one or more second transmission modes. The operations of block 2120 may be performed according to the methods described with reference to FIGS. 1 through 10. In certain examples, aspects of the operations of block 2120 may be performed by a BSS associator as described with reference to FIGS. 15 through 18.

At block 2125 the STA 115 may receive, in the probe response from the first BSS of the AP, an indication of the second BSS based at least in part on a transmission mode supported by the second BSS, the indication received in the probe response. The operations of block 2125 may be performed according to the methods described with reference to FIGS. 1 through 10. In certain examples, aspects of the operations of block 2125 may be performed by a BSS manager as described with reference to FIGS. 15 through 18.

At block 2130 the STA 115 may determine to associate with the second BSS based at least in part on the received indication. The operations of block 2130 may be performed according to the methods described with reference to FIGS. 1 through 10. In certain examples, aspects of the operations of block 2130 may be performed by a BSS associator as described with reference to FIGS. 15 through 18.

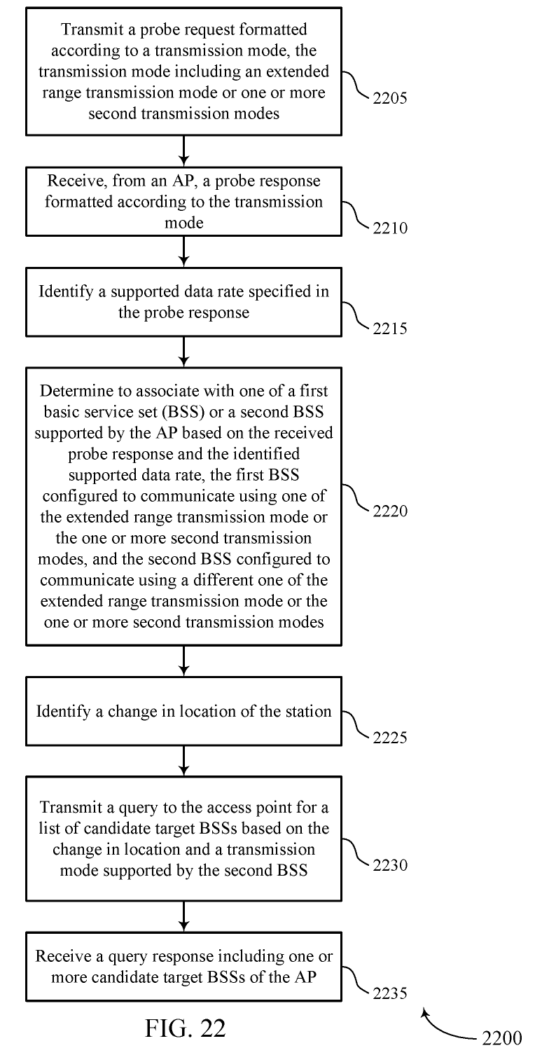

FIG. 22 shows a flowchart illustrating a method 2200 for multiple basic service sets for ER operation in accordance with various aspects of the present disclosure. The operations of method 2200 may be implemented by a STA 115 or its components as described herein. For example, the operations of method 2200 may be performed by a STA BSS manager as described with reference to FIGS. 15 through 18. In some examples, a STA 115 may execute a set of codes to control the functional elements of the device to perform the functions described below. Additionally or alternatively, the STA 115 may perform aspects of the functions described below using special-purpose hardware.

At block 2205 the STA 115 may transmit a probe request formatted according to a transmission mode, the transmission mode comprising an ER transmission mode or one or more second transmission modes. The operations of block 2205 may be performed according to the methods described with reference to FIGS. 1 through 10. In certain examples, aspects of the operations of block 2205 may be performed by a transmission mode manager as described with reference to FIGS. 15 through 18.

At block 2210 the STA 115 may receive, from an AP, a probe response formatted according to the transmission mode. The operations of block 2210 may be performed according to the methods described with reference to FIGS. 1 through 10. In certain examples, aspects of the operations of block 2210 may be performed by a probe response manager as described with reference to FIGS. 15 through 18.

At block 2215 the STA 115 may identify a supported data rate specified in the probe response. The operations of block 2215 may be performed according to the methods described with reference to FIGS. 1 through 10. In certain examples, aspects of the operations of block 2215 may be performed by a probe response manager as described with reference to FIGS. 15 through 18.

At block 2220 the STA 115 may determine to associate with one of a first BSS or a second BSS supported by the AP based at least in part on the received probe response and the identified supported data rate, the first BSS configured to communicate using one of the ER transmission mode or the one or more second transmission modes, and the second BSS configured to communicate using a different one of the ER transmission mode or the one or more second transmission modes. The operations of block 2220 may be performed according to the methods described with reference to FIGS. 1 through 10. In certain examples, aspects of the operations of block 2220 may be performed by a BSS associator as described with reference to FIGS. 15 through 18.

At block 2225 the STA 115 may identify a change in location of the station. The operations of block 2225 may be performed according to the methods described with reference to FIGS. 1 through 10. In certain examples, aspects of the operations of block 2225 may be performed by a location identifier as described with reference to FIGS. 15 through 18.

At block 2230 the STA 115 may transmit a query to the access point for a list of candidate target BSSs based at least in part on the change in location and a transmission mode supported by the second BSS. The operations of block 2230 may be performed according to the methods described with reference to FIGS. 1 through 10. In certain examples, aspects of the operations of block 2230 may be performed by a BSS querier as described with reference to FIGS. 15 through 18.

At block 2235 the STA 115 may receive a query response comprising one or more candidate target BSSs of the AP. The operations of block 2235 may be performed according to the methods described with reference to FIGS. 1 through 10. In certain examples, aspects of the operations of block 2235 may be performed by a BSS manager as described with reference to FIGS. 15 through 18.

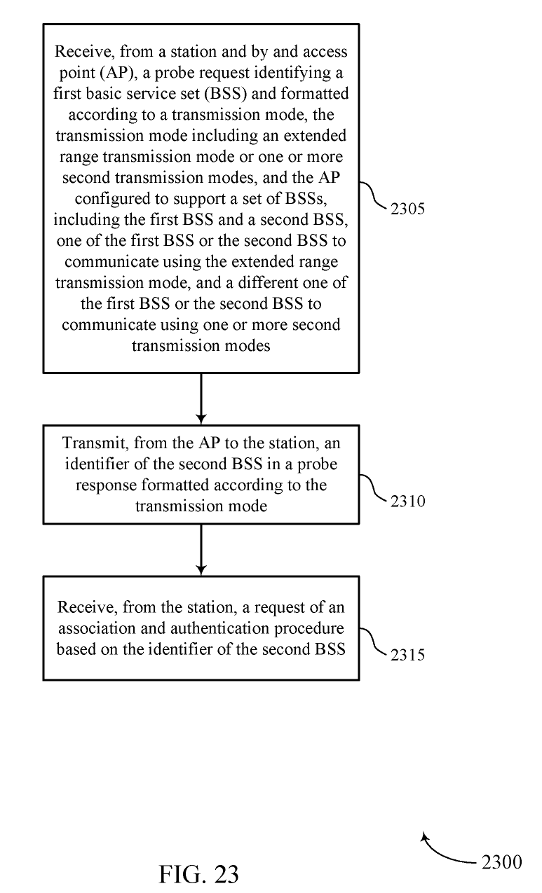

FIG. 23 shows a flowchart illustrating a method 2300 for multiple basic service sets for ER operation in accordance with various aspects of the present disclosure. The operations of method 2300 may be implemented by an AP 105 or its components as described herein. For example, the operations of method 2300 may be performed by an AP BSS manager as described with reference to FIGS. 11 through 14. In some examples, an AP 105 may execute a set of codes to control the functional elements of the device to perform the functions described below. Additionally or alternatively, the AP 105 may perform aspects of the functions described below using special-purpose hardware.

At block 2305 the AP 105 may receive, from a station, a probe request identifying a first BSS and formatted according to a transmission mode, the transmission mode comprising an ER transmission mode or one or more second transmission modes, and the AP configured to support a plurality of BSSs, including the first BSS and a second BSS, one of the first BSS or the second BSS to communicate using the ER transmission mode, and a different one of the first BSS or the second BSS to communicate using one or more second transmission modes. The operations of block 2305 may be performed according to the methods described with reference to FIGS. 1 through 10. In certain examples, aspects of the operations of block 2305 may be performed by a probe request manager as described with reference to FIGS. 11 through 14.

At block 2310 the AP 105 may transmit, to the station, an identifier of the second BSS in a probe response formatted according to the transmission mode. The operations of block 2310 may be performed according to the methods described with reference to FIGS. 1 through 10. In certain examples, aspects of the operations of block 2310 may be performed by a probe response manager as described with reference to FIGS. 11 through 14.

At block 2315 the AP 105 may receive, from the station, a request of an association and authentication procedure based at least in part on the identifier of the second BSS. The operations of block 2315 may be performed according to the methods described with reference to FIGS. 1 through 10. In certain examples, aspects of the operations of block 2315 may be performed by an association/authentication manager as described with reference to FIGS. 11 through 14.

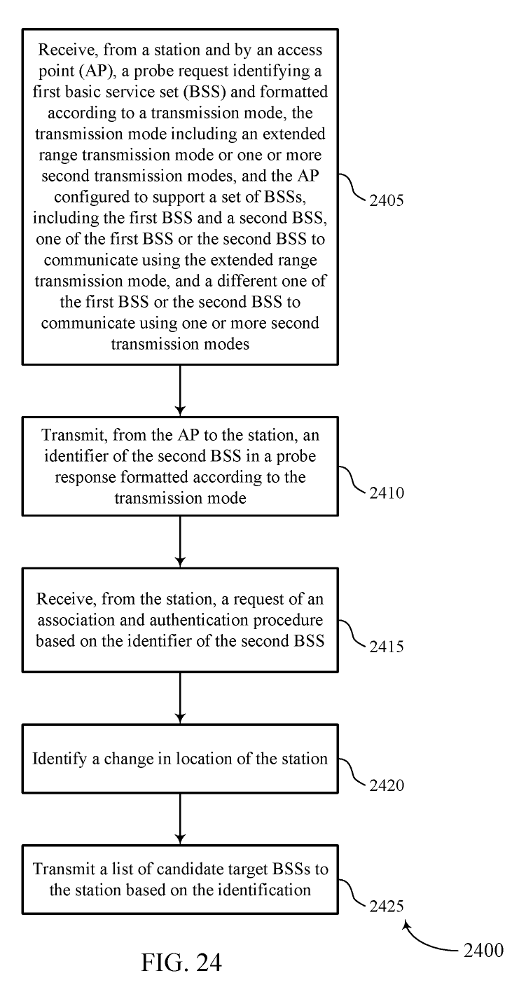

FIG. 24 shows a flowchart illustrating a method 2400 for multiple basic service sets for ER operation in accordance with various aspects of the present disclosure. The operations of method 2400 may be implemented by an AP 105 or its components as described herein. For example, the operations of method 2400 may be performed by an AP BSS manager as described with reference to FIGS. 11 through 14. In some examples, an AP 105 may execute a set of codes to control the functional elements of the device to perform the functions described below. Additionally or alternatively, the AP 105 may perform aspects of the functions described below using special-purpose hardware.

At block 2405 the AP 105 may receive, from a station, a probe request identifying a first BSS and formatted according to a transmission mode, the transmission mode comprising an ER transmission mode or one or more second transmission modes, and the AP configured to support a plurality of BSSs, including the first BSS and a second BSS, one of the first BSS or the second BSS to communicate using the ER transmission mode, and a different one of the first BSS or the second BSS to communicate using one or more second transmission modes. The operations of block 2405 may be performed according to the methods described with reference to FIGS. 1 through 10. In certain examples, aspects of the operations of block 2405 may be performed by a probe request manager as described with reference to FIGS. 11 through 14.

At block 2410 the AP 105 may transmit, to the station, an identifier of the second BSS in a probe response formatted according to the transmission mode. The operations of block 2410 may be performed according to the methods described with reference to FIGS. 1 through 10. In certain examples, aspects of the operations of block 2410 may be performed by a probe response manager as described with reference to FIGS. 11 through 14.

At block 2415 the AP 105 may receive, from the station, a request of an association and authentication procedure based at least in part on the identifier of the second BSS. The operations of block 2415 may be performed according to the methods described with reference to FIGS. 1 through 10. In certain examples, aspects of the operations of block 2415 may be performed by an association/authentication manager as described with reference to FIGS. 11 through 14.

At block 2420 the AP 105 may identify a change in location of the station. The operations of block 2420 may be performed according to the methods described with reference to FIGS. 1 through 10. In certain examples, aspects of the operations of block 2420 may be performed by a STA locator as described with reference to FIGS. 11 through 14.

At block 2425 the AP 105 may transmit a list of candidate target BSSs to the station based at least in part on the identification. The operations of block 2425 may be performed according to the methods described with reference to FIGS. 1 through 10. In certain examples, aspects of the operations of block 2425 may be performed by a BSS manager as described with reference to FIGS. 11 through 14.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

downlink transmissions described herein may also be called forward link transmissions while the uplink transmissions may also be called reverse link transmissions. Each communication link described herein—including, for example, WLAN 100 and WLAN 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

Claims what is claimed is:

1. An apparatus for wireless communication at a station, comprising:
a processor;
memory in electronic communication with the processor; and
instructions stored in the memory and operable, when executed by the processor, to cause the apparatus to:
transmit a probe request formatted according to a transmission mode, the transmission mode comprising an extended range transmission mode or one or more second transmission modes;
receive, from an access point (AP), a probe response formatted according to the transmission mode;
identify a supported data rate specified in the probe response; and
determine to associate with one of a first basic service set (BSS) or a second BSS supported by the AP based at least in part on the received probe response and the identified supported data rate, the first BSS configured to communicate using one of the extended range transmission mode or the one or more second transmission modes, and the second BSS configured to communicate using a different one of the extended range transmission mode or the one or more second transmission modes.

2. The apparatus of claim 1, wherein the instructions are further executable by the processor to cause the apparatus to:
receive the probe response from the AP based at least in part on the transmission mode format associated with the probe request.

3. The apparatus of claim 1, wherein the instructions are further executable by the processor to cause the apparatus to:
receive, in the probe response from the first BSS of the AP, an indication of the second BSS based at least in part on a transmission mode supported by the second BSS, the indication received in the probe response; and
determine to associate with the second BSS based at least in part on the received indication.

4. The apparatus of claim 1, wherein the instructions are further executable by the processor to cause the apparatus to:
associate with the determined one of the first BSS or the second BSS; and
receive, from the AP, a request to move to being associated with a different one of the first BSS or the second BSS based at least in part on a transmission mode supported by the second BSS.

5. The apparatus of claim 1, wherein the instructions are further executable by the processor to cause the apparatus to:
identify a change in location of the station;
transmit a query to the access point for a list of candidate target BSSs based at least in part on the change in location and a transmission mode supported by the second BSS; and
receive a query response comprising one or more candidate target BSSs of the AP.

6. The apparatus of claim 1, wherein the instructions are further executable by the processor to cause the apparatus to:
receive a beacon from the AP;
identify signal strength associated with the received beacon; and
determine to associate with the one of the first BSS or the second BSS based at least in part on the received probe response, the identified signal strength, and a supported transmission mode for communication in the second BSS.

7. The apparatus of claim 1, wherein the instructions are further executable by the processor to cause the apparatus to:
identify a location of the station with reference to the AP, a proximity of the station to the AP, or a combination thereof; and
determine to associate with the first BSS or the second BSS based at least in part on the received probe response, the identified location, proximity, or a combination thereof, and a transmission mode supported by the second BSS.

8. The apparatus of claim 1, wherein the first BSS and the second BSS have an equivalent security profile.

9. The apparatus of claim 1, wherein the apparatus is a wireless communication terminal and further comprises an antenna and a transceiver.

10. The apparatus of claim 1, wherein the probe response includes a BSS identifier associated with the first BSS or the second BSS.

11. An apparatus for wireless communication at an access point (AP), comprising:
a processor;
memory in electronic communication with the processor; and
instructions stored in the memory and operable, when executed by the processor, to cause the apparatus to:
receive, at the AP, a wireless communication from a station, the AP configured to support a plurality of basic service sets (BSSs), including a first BSS to communicate using an extended range transmission mode and a second BSS to communicate using one or more non-extended range transmission modes;
identify that the wireless communication is formatted according to the extended range transmission mode or one of the one or more non-extended range transmission modes; and
perform an association and authentication procedure with the station to establish:
a first communication link of the first BSS between the AP and the station based at least in part on identifying that the wireless communication is formatted according to the extended range transmission mode, or
a second communication link of the second BSS between the AP and the station based at least in part on identifying that the wireless communication is formatted according to the non-extended range transmission mode.

12. The apparatus of claim 11, wherein:
the first BSS is used by the AP for an exclusive communication of data, control, and management frames formatted according to the extended range transmission mode; and
the second BSS is used by the AP for a communication of data, control, and management frames formatted according to the one or more non-extended range transmission modes.

13. The apparatus of claim 11, wherein the first BSS is an extended range BSS and the second BSS is a non-extended range BSS.

14. The apparatus of claim 11, wherein the first BSS is associated with a first BSS identifier and the second BSS is associated with a second BSS identifier, the first BSS identifier different from the second BSS identifier.

15. The apparatus of claim 11, wherein the first communication link of the first BSS and the second communication link of the second BSS are associated with a same operating channel.

16. The apparatus of claim 11, wherein the first communication link of the first BSS and the second communication link of the second BSS are associated with different operating channels.

17. An apparatus for wireless communication at an access point (AP), comprising:
a processor;
memory in electronic communication with the processor; and
instructions stored in the memory and operable, when executed by the processor, to cause the apparatus to:
receive, from a station and by the AP, a probe request identifying a first basic service set (BSS) and formatted according to a transmission mode, the transmission mode comprising an extended range transmission mode or one or more second transmission modes, and the AP configured to support a plurality of BSSs, including the first BSS and a second BSS, one of the first BSS or the second BSS to communicate using the extended range transmission mode, and a different one of the first BSS or the second BSS to communicate using one or more second transmission modes;
transmit, to the station, an identifier of the second BSS in a probe response formatted according to the transmission mode; and
receive, from the station, a request of an association and authentication procedure based at least in part on the identifier of the second BSS.

18. The apparatus of claim 17, wherein the instructions are further executable by the processor to cause the apparatus to:
identify that the probe request is formatted according to the first transmission mode; and
refrain from transmitting a probe response based at least in part on the identification.

19. The apparatus of claim 17, wherein the instructions are further executable by the processor to cause the apparatus to:
associate the station with the second BSS; and
transmit, to the station, a request for the station to move from being associated with the second BSS to being associated with the first BSS.

20. The apparatus of claim 17, wherein the instructions are further executable by the processor to cause the apparatus to:
identify a change in location of the station; and
transmit a list of candidate target BSSs to the station based at least in part on the identification.

21. The apparatus of claim 17, wherein the first BSS and the second BSS have an equivalent security profile.

22. A method for wireless communication at a station, comprising:
transmitting a probe request formatted according to a transmission mode, the transmission mode comprising an extended range transmission mode or one or more second transmission modes;
receiving, from an access point (AP), a probe response formatted according to the transmission mode;
identifying a supported data rate specified in the probe response; and
determining to associate with one of a first basic service set (BSS) or a second BSS supported by the AP based at least in part on the received probe response and the identified supported data rate, the first BSS configured to communicate using one of the extended range transmission mode or the one or more second transmission modes, and the second BSS configured to communicate using a different one of the extended range transmission mode or the one or more second transmission modes.

23. The method of claim 22, further comprising:
receiving the probe response from the AP based at least in part on the transmission mode format associated with the probe request.

24. The method of claim 22, further comprising:
receiving, in the probe response from the first BSS of the AP, an indication of the second BSS based at least in part on a transmission mode supported by the second BSS, the indication received in the probe response; and
determining to associate with the second BSS based at least in part on the received indication.

25. The method of claim 22, further comprising:
associating with the determined one of the first BSS or the second BSS; and
receiving, from the AP, a request to move to being associated with a different one of the first BSS or the second BSS based at least in part on a transmission mode supported by the second BSS.

26. The method of claim 22, further comprising:
identifying a change in location of the station;
transmitting a query to the access point for a list of candidate target BSSs based at least in part on the change in location and a transmission mode supported by the second BSS; and
receiving a query response comprising one or more candidate target BSSs of the AP.

27. The method of claim 22, further comprising:
receiving a beacon from the AP;
identifying signal strength associated with the received beacon; and
determining to associate with the one of the first BSS or the second BSS based at least in part on the received probe response, the identified signal strength, and a supported transmission mode for communication in the second BSS.

28. The method of claim 22, further comprising:
identifying a location of the station with reference to the AP, a proximity of the station to the AP, or a combination thereof; and
determining to associate with the first BSS or the second BSS based at least in part on the received probe response, the identified location, proximity, or a combination thereof, and a transmission mode supported by the second BSS.

29. The method of claim 22, wherein the first BSS and the second BSS have an equivalent security profile.

30. The method of claim 22, wherein the probe response includes a BSS identifier associated with the first BSS or the second BSS.
